(19) United States
(12) Patent Application Publication
(10) Pub. No.: US 2022/0091586 A1
(43) Pub. Date: Mar. 24, 2022

(54) DATA PROCESSING DEVICE AND DATA PROCESSING METHOD

(71) Applicant: SONY GROUP CORPORATION, Tokyo (JP)

(72) Inventors: Masahiro FUJITA, Saitama (JP); Kaoru YOSHIDA, Kanagawa (JP); Michael Siegfried SPRANGER, Tokyo (JP)

(73) Assignee: SONY GROUP CORPORATION, Tokyo (JP)

(21) Appl. No.: 17/424,343

(22) PCT Filed: Feb. 14, 2020
(86) PCT No.: PCT/JP2020/005728

§ 371 Date: Jul. 20, 2021

(30) Foreign Application Priority Data
Mar. 1, 2019 (JP) 2019-038069

(51) Int. Cl. G05B 19/4155; A47J 44/00; A23L 5/10; G05B 19/042; G06N 3/08

(52) U.S. Cl. CPC G05B 19/4155; A47J 44/00; A23L 5/10; G05B 19/042; G05B 2219/2643; A23V 2002/00; G05B 2219/40269; G05B 2219/40307; G06N 3/08

(57) ABSTRACT

There is provided a data processing device and a data processing method capable of improving reproducibility in a case where a cooking robot reproduces the same dish as a dish cooked by a cook. The data processing device according to one aspect of the present technology generates recipe data including a data set used when a cooking robot performs a cooking operation, the data set linking cooking operation data in which information regarding an ingredient of a dish and information regarding an operation of a cook in a cooking process using the ingredient are described, and sensation data indicating a sensation of the cook measured in conjunction with progress of the cooking process. The present technology can be applied to a computer that controls cooking in a cooking robot.

### TECHNICAL FIELD

The present technology relates to a data processing device and a data processing method, and more particularly relates to a data processing device and a data processing method capable of improving reproducibility in a case where a cooking robot reproduces the same dish as a dish cooked by a cook.

### BACKGROUND ART

There has been studied a technique of reproducing a dish made by a cook on a cooking robot side by sensing movement of the cook during cooking, and storing and transmitting data of a sensing result. A cooking operation by the cooking robot is performed such that, for example, the same movement as the movement of the hand of the cook is achieved on the basis of the sensing result.

### CITATION LIST

### Patent Document

Patent Document 1: Japanese Translation of PCT International Application Publication No. 2017-506169
Patent Document 2: Japanese Translation of PCT International Application Publication No. 2017-536247

### SUMMARY OF THE INVENTION

### Problems to be Solved by the Invention

By the cooking method using the conventional cooking robot, it is practically difficult to reproduce the dish as intended by the cook even in a case where the cooking process proceeds according to the recipe.

This is because, in addition to the fact that the senses of taste, smell, and the like are different depending on the cook or a person who eats the dish, types, sizes, textures, production areas, and the like of ingredients are different between the cook side and the reproduction side, types, abilities, and the like of cooking utensils are different, and the cooking environment such as temperature and humidity is different.

The present technology has been made in view of such a situation, and an object thereof is to enable improvement or reproducibility in a case where a cooking robot reproduces the same dish as a dish made by a cook.

### Solutions to Problems

A data processing device according to one aspect of the present technology includes a recipe data generation unit that generates recipe data including a data set used when a cooking robot performs a cooking operation, the data set linking cooking operation data in which information regarding an ingredient of a dish and information regarding an operation of a cook in a cooking process using the ingredient are described, and sensation data indicating a sensation of the cook measured in conjunction with progress of the cooking process.

In one aspect of the present technology, there is generated recipe data including a data set used when a cooking robot performs a cooking operation, the data set linking cooking operation data in which information regarding an ingredient of a dish and information regarding an operation of a cook in a cooking process using the ingredient are described, and sensation data indicating a sensation of the cook measured in conjunction with progress of the cooking process.

### BRIEF DESCRIPTION OF DRAWINGS

FIG. 1 is a diagram illustrating an example of overall processing in a cooking system according to one embodiment of the present technology.

FIG. 2 is a diagram describing a difference in ingredients used on each of a chef side and a reproduction side.

FIG. 3 is a diagram illustrating an example of description contents of recipe data.

FIG. 4 is a diagram illustrating an example of information included in a cooking process data set.

FIG. 5 is a diagram illustrating examples of components of flavor. FIG. 6 is a diagram illustrating a calculation example of taste subjective information.

FIG. 7 is a diagram illustrating an example of a chart of the taste subjective information.

FIG. 8 is a diagram illustrating an example of the recipe data.

FIG. 9 is a diagram illustrating an example of a flow of generating the recipe data.

FIG. 10 is a diagram illustrating an example of a flow of reproduction of a dish based on the recipe data.

FIG. 11 is a diagram collectively illustrating a flow on the chef side and a flow on the reproduction side.

FIG. 12 is a diagram illustrating an example of other description contents of the recipe data.

FIG. 13 is a diagram illustrating a configuration example of a cooking system according to the one embodiment of the present technology.

FIG. 14 is a diagram illustrating another configuration example of the cooking system.

FIG. 15 is a diagram illustrating an arrangement example of a control device.

FIG. 16 is a diagram illustrating a configuration example around a kitchen where a chef performs cooking.

FIG. 17 is a view illustrating an example of a use state of a taste sensor.

FIG. 18 is a block diagram illustrating a configuration example on the chef side.

FIG. 19 is a block diagram illustrating a configuration example of hardware of a data processing device.

FIG. 20 is a block diagram illustrating a functional configuration example of the data processing device.

FIG. 21 is a perspective view illustrating as appearance of a cooking robot.

FIG. 22 is an enlarged view illustrating a state of cooking arms.

FIG. 23 is a view illustrating an appearance of a cooking arm.

FIG. 24 is a diagram illustrating an example of a movable range of each part of the cooking arm.

FIG. 25 is a diagram illustrating ac example of connection between the cooking arms and a controller.

FIG. 26 is a block diagram illustrating an example of a configuration of the cooking robot and surroundings.

FIG. 27 is a block diagram illustrating a functional configuration example of the control device.

FIG. 28 is a block diagram illustrating a configuration example of a flavor information processing unit.

FIG. 29 is a flowchart describing recipe data generation processing of the data processing device.

FIG. 30 is a flowchart describing flavor information generation processing performed in step S5 in FIG. 29.

FIG. 31 is a flowchart describing dish reproduction processing of the control device.

FIG. 32 is a flowchart describing flavor measuring processing performed in step S36 in FIG. 31.

FIG. 33 is a flowchart describing flavor adjustment processing performed in step S38 in FIG. 31.

FIG. 34 is a flowchart describing taste adjustment processing performed in step S61 in FIG. 33.

FIG. 35 is a diagram illustrating an example of planning.

FIG. 36 is a flowchart describing flavor adjustment processing of the control device.

FIG. 37 is a diagram illustrating an example of flavor determination.

FIG. 38 is a diagram illustrating an example of the flavor determination using flavor subjective information.

FIG. 39 is a diagram illustrating an example of a model for generating sensor data.

FIG. 40 is a flowchart describing flavor sensor information correction processing of the control device.

FIG. 41 is a diagram illustrating another configuration. example of the cooking system.

### MODE FOR CARRYING OUT THE INVENTION

<Overview of Present Technology>

The present technology focuses on a difference (difference amount) between a sensation when a cook makes a dish and a sensation when cooking is performed on the basis of a recipe created by the cook, and links sensation data, which is obtained by converting a sensation of the cook at the time of making the dish into data, to data describing ingredients and a cooking process and manages the data as recipe data.

Furthermore, the present technology adjusts a cooking operation of a cooking robot on the basis of the sensation of the cook represented by the sensation data, thereby enabling the cooking robot side to reproduce a dish having a flavor as intended by the cook.

Moreover, the present technology adjusts the ingredients and the cooking operation by using data sensed in a cooking operation at a time of reproduction in addition to the sensation. data, thereby achieving flexible cooking in accordance with characteristics (attributes, states, and the like) of a person who eats the dish.

Hereinafter, a mode for carrying out the present technology will be described. The description will be made in the following order. p 1. Generation of recipe data and reproduction of dish in cooking system

2. Regarding recipe data

3. Example of flows of generation of recipe data and reproduction of dish

4. Configuration example of cooking system

5. Operation of cooking system

6. Modification example

### GENERATION OF RECIPE DATA AND REPRODUCTION OF DISH IN COOKING SYSTEM

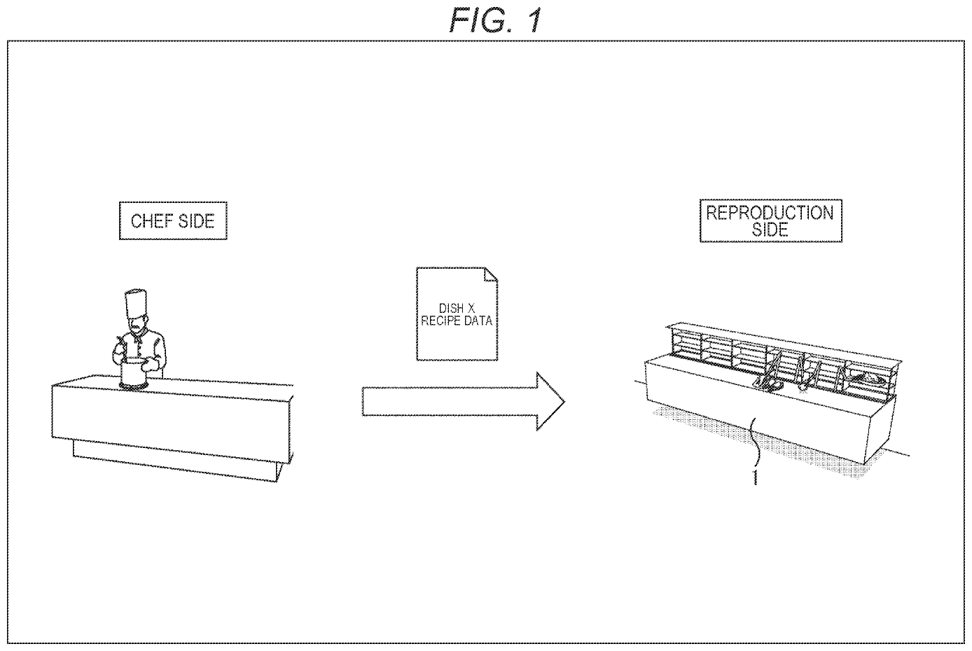

FIG. 1 is a diagram illustrating an example of overall processing in a cooking system according to one embodiment of the present technology.

As illustrated in FIG. 1, the cooking system includes a configuration on a side of a chef who performs cooking and a configuration on a reproduction side that reproduces a dish made by the chef.

The configuration on the chef side is, for example, a configuration provided in a certain restaurant, and the configuration on the reproduction side is, for example, a configuration provided in a general home. As a configuration on the reproduction side, a cooking robot 1 is prepared.

The cooking system of FIG. 1 is a system that reproduces the same dish as a dish made by the chef, by the cooking robot 1 as a configuration on the reproduction side. The cooking robot 1 is a robot having a drive system device such as a cooking arm and various sensors and is provided with a function of performing cooking.

From the configuration on the chef side to the configuration on the reproduction side including the cooking robot 1, recipe data is provided as indicated by an arrow. As will be described in detail later, the recipe data describes information regarding a dish made by the chef including ingredients of the dish.

In the configuration on the reproduction side, a cooking operation of the cooking robot 1 is controlled on the basis of recipe data, thereby, reproducing the dish. For example, a dish is reproduced by causing the cooking robot 1 to perform the cooking operation for achieving the same process as the cooking process of the chef.

Although the chef is illustrated as a cook who performs cooking, the cooking system of FIG. 1 can be applied to cases where any person performs cooking regardless of names such as a chef and a cook and a role in a kitchen.

Furthermore, in FIG. 1, only a configuration on the side of one chef is illustrated, but the cooking system includes configurations on sides of a plurality of chefs provided respectively in a plurality of restaurants and the like. To the configuration on the reproduction side, for example, recipe data of a predetermined dish made by a predetermined chef selected by a person who eats the dish reproduced by the cooking robot 1 is provided.

Note that the dish means a product completed through cooking. The cooking means a process of making a dish or an action (operation) of making a dish.

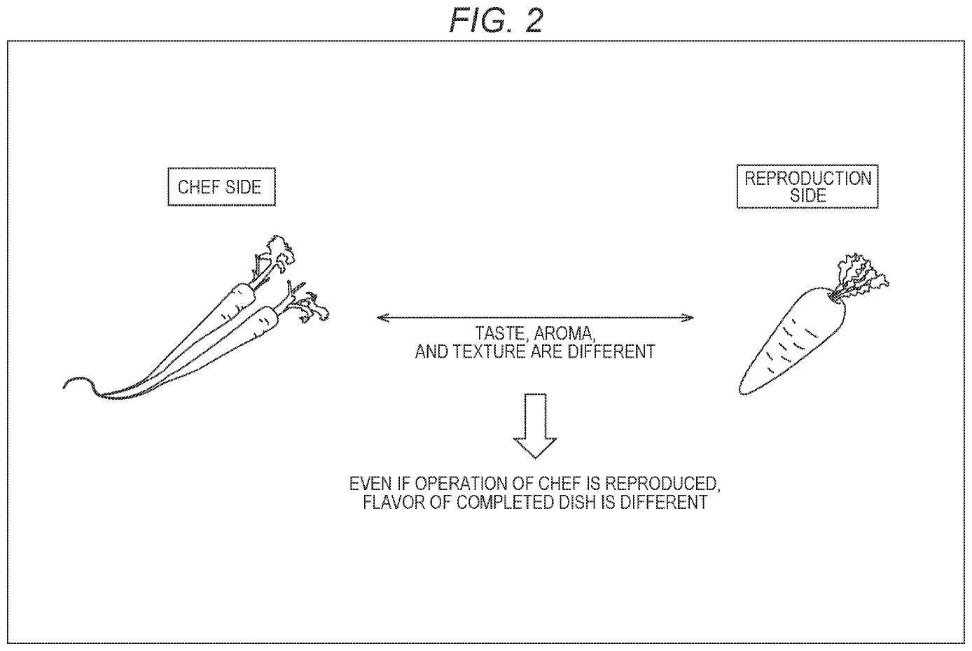

FIG. 2 is a diagram describing a difference in ingredients used on each of the chef side and the reproduction side.

For example, in a case where a carrot is used for cooking by the chef, information indicating that the carrot is used as an ingredient is described in the recipe data. Furthermore, information associated with a cooking process using the carrot is described.

Similarly, on the reproduction side, the cooking operation using the carrot is performed on the basis of the recipe data.

Here, even among ingredients classified as the same “carrot”, the taste, aroma, and texture of the carrot prepared on the chef side and the carrot prepared on the reproduction side are different depending on a difference in type, a difference in production area, a difference in harvest time, a difference in growth situation, a difference in environment after harvest, and the like. There are no completely the same ingredients among ingredients as natural objects.

Therefore, even if the cooking robot 1 is caused to perform completely the same cooking operation as the operation of the chef, the flavor of the dish completed using the carrot is different. Details of the flavor will be described later.

Although a plurality of cooking processes is required until one dish is completed, even when an intermediate dish that is completed through one cooking process using the carrot is seen, the flavor of the dish is different between the chef side and the reproduction side.

Similarly, depending on a difference in seasoning used in a certain cooking process, a difference in cooking tools such as a kitchen knife and a pot used for cooking, a difference in equipment such as heating power, and the like, the flavor of a completed dish or an intermediate dish is different between the chef side and the reproduction side.

Therefore, in the cooking system of FIG. 1, the flavor obtained as a sensation by the chef at the time of making a dish is measured, for example, every time one cooking process is performed. In the recipe data provided to the reproduction side, sensation data obtained by converting the flavor obtained by the chef into data is described in a manner linked to, for example, information of an ingredient and an operation associated with one cooking process.

### REGARDING RECIPE DATA

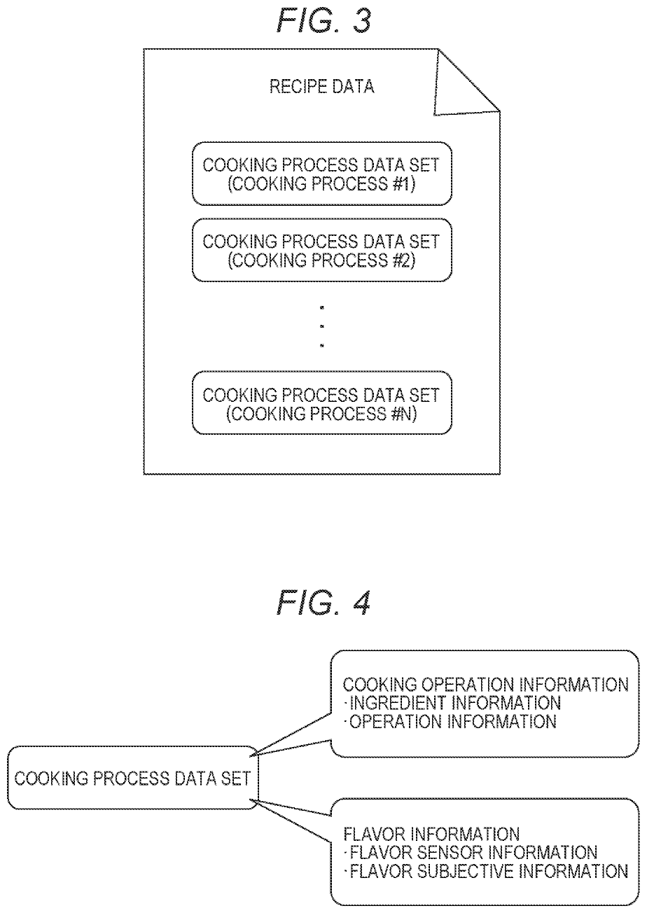

FIG. 3 is a diagram. illustrating an example of description contents of recipe data.

As illustrated in FIG. 3, one recipe data includes a plurality of cooking process data sets. In the example of FIG. 3, a cooking process data set associated with a cooking process #1, a cooking process data set related to a cooking process #2, . . . , and a cooking process data set related to cooking process #N are included.

Thus, in the recipe data, information associated with one cooking process is described as one cooking process data set.

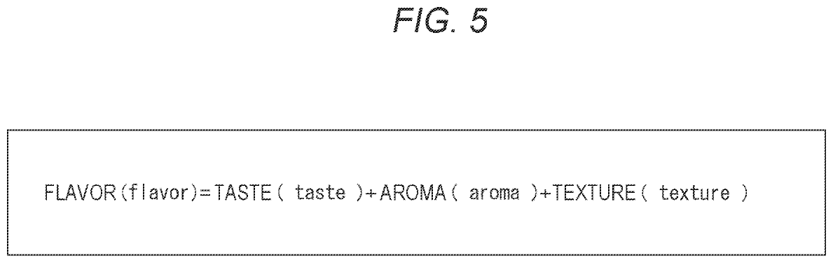

FIG. 4 is a diagram illustrating an example of information included in a cooking process data set.

As illustrated in a balloon of FIG. 4, the cooking process data set includes cooking operation information that is information regarding a cooking operation for achieving the cooking process and flavor information that is information regarding a flavor of an ingredient that has undergone the cooking process.

1. Cooking Operation Information

The cooking operation information includes ingredient information and operation information.

1-1. Ingredient Information

The ingredient information is information regarding ingredients used by the chef in the cooking process. The information. regarding ingredients includes information indicating a type of ingredient, an amount of ingredient, a size of ingredient, and the like.

For example, in a case where the chef performs cooking using a carrot in a certain cooking process, information indicating that the carrot is used is included in the ingredient information. The ingredient information also includes information indicating various foods used by the chef as ingredients of the dish, such as water and seasoning, and the like. Foods are various things that can be eaten by a person.

Note that the ingredients include not only an ingredient that has not been cooked at all but also a cooked (pre-processed) ingredient obtained by performing certain cooking. The ingredient information included in the cooking operation information of a certain cooking process includes information of ingredients having undergone a previous cooking process.

The ingredients used by the chef are recognized, for example, by analyzing an image captured by a camera of the chef who is cooking. The ingredient information is generated on the basis of a recognition result of the ingredients. The image captured by the camera may be a moving image or a still image.

At the time of generating the recipe data, the ingredient information may be registered by the chef or by another person such as a staff supporting the chef.

1-2. Operation Information

The operation information is information regarding movement of the chef in the cooking process. The information regarding the movement of the chef includes information indicating the type of a cooking tool used by the chef, the movement of the body of the chef at each time including movement of the hands, the standing position of the chef at each time, and the like.

For example, in a case where the chef cuts a certain ingredient by using a kitchen knife, information indicating that the kitchen knife is used as a cooking tool, and information indicating a cutting position, the number of times of cutting, a force level of a cutting method, an angle, a speed, and the like are included in the operation information.

Furthermore, in a case where the chef stirs a pot containing a liquid as an ingredient using a ladle, the operation information includes information indicating that the ladle has been used as a cooking tool, and information indicating a force level, an angle, a speed, a time, and the like of the manner of stirring.

In a case where a certain ingredient is baked by a chef using an oven, information indicating that the oven is used as a cooking tool, information indicating heating power of the oven, baking time, and the like are included in the operation information.

In a case where the chef performs serving, the operation information includes information of serving manners indicating a dish used for serving, how to arrange the ingredients, the color of the ingredients, and the like.

The movement of the chef is recognized, for example, by analyzing an image of the chef who is cooking captured by a camera, or by analyzing sensor data measured by a sensor worn by the chef. The operation information is generated on the basis of a recognition result of the movement of the chef.

2. Flavor Information

As illustrated in FIG. 4, the flavor information includes flavor sensor information and flavor subjective information. Flavors are obtained as sensations. The flavor information included in the cooking process data set corresponds to sensation data obtained by converting a sensation of the chef into data.

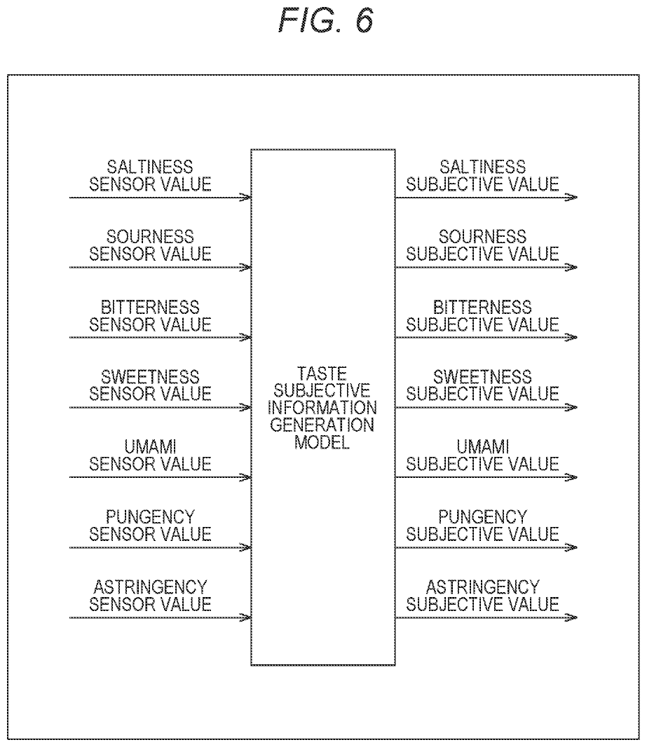

FIG. 5 is a diagram illustrating examples of components of flavor.

As illustrated in FIG. 5, deliciousness sensed by a human brain, that is, “flavor” is mainly formed by combining a taste obtained by human's sense of taste, an aroma obtained by human's sense of smell, and a texture obtained by human's sense of touch.

How the taste is felt also varies depending on the sensible temperature and the color of the ingredient, and thus the flavor includes the sensible temperature and the color.

Each component of flavor will be described.

(1) Taste

Taste includes five types of tastes (saltiness, sourness, bitterness, sweetness, and umami) that can be sensed by taste receptor cells is the tongue and oral cavity. The saltiness, sourness, bitterness, sweetness, and umami are called basic five tastes.

Furthermore, the taste includes, is addition to the basic five tastes, a pungency felt by vanilloid receptors belonging to the transient receptor potential (TRP) channel family, and the like, which is a pain sensation not only in the oral cavity but also in the whole body. Depending on the concentration, the taste overlaps with the bitterness, but astringency is also a kind of taste.

Each taste will be described.

Saltiness

Substances that cause a feeling of saltiness include minerals (Na, K, Fe, Mg, Ca, Cu, Mn, Al, Zn, and the like) that produce a salt by ionic bonding.

Sourness

As substances that cause a feeling of sourness, there are acids such as citric acid and acetic acid. In general, sourness is felt depending on a decrease in pH (for example, about pH 3).

Sweetness

As substances that cause a feeling of sweetness, there are saccharides such as sucrose and glucose, lipids, amino acids such as glycine, and artificial sweeteners.

Umami

As substances that cause a feeling of umami, there are amino acids such as glutamic acid and aspartic acid, nucleic acid derivatives such as inosinic acid, guanylic acid, and xanthylic acid, organic acids such as succinic acid, and salts.

Bitterness

As substances that cause a feeling of bitterness, there are alkaloids such as caffeine, theobromine, nicotine, catechin, humulones such as terpenoid, limonin, cucurbitacin, naringin of a flavanone glycoside, a bitter amino acid, a bitter peptide, a bile acid, and inorganic salts such as a calcium salt and a magnesium salt.

Astringency

As substances that cause a feeling of astringency, there are polyphenols, tannin, catechin, polyvalent. ions (Al, Zn, Cr), ethanol, and acetone. The astringency is recognized or measured as part of the bitterness.

Pungency

As a substance that causes a feeling of pungency, there is a capsaicinoid. Capsaicin, which is a component of hot capsicum and various spices, and menthol, which is a component of peppermint that gives a cool sensation, are recognized as a pain sensation rather than a sense of taste by a temperature sensitive receptor of the TRP channel family.

(2) Aroma

An aroma is perceived by a volatile low molecular weight organic compound having a molecular weight of 300 or less that is recognized (bound) by olfactory receptors expressed in the nasal cavity and the nasopharynx.

(3) Texture

Texture is an index that is what is called palate feeling, and is represented by hardness, stickiness, viscosity, cohesiveness, polymer content, moisture content (moisture), oil content (greasiness), and the like.

(4) Sensible Temperature (Apparent Temperature)

The sensible temperature is a temperature felt by human skin. The sensible temperature includes not only the temperature of food itself but temperature sensation that can also be sensed by superficial part of the skin in response to components of food, such as feeling cool by food containing a volatile substance like mint or feeling warm by food containing a pungent component like capsicum.

(5) Color

The color of food reflects pigments and components of bitterness and astringency contained in food. For example, plant-derived foods include pigments produced by photosynthesis and components related to bitterness and astringency of polyphenols. An optical measurement method makes it possible to estimate components contained in food from the color of food.

2-1. Flavor Sensor Information

The flavor sensor information constituting the flavor information is sensor data obtained by measuring the flavor of an ingredient by a sensor. The sensor data obtained by measuring, with a sensor, the flavor of an ingredient that has not been cocked at all may be included in the flavor information as the flavor sensor information.

The flavor is formed by a taste, an aroma, a texture, a sensible temperature, and a color, and thus the flavor sensor information includes sensor data related to taste, sensor data related to aroma, sensor data related to texture, sensor data related to sensible temperature, and sensor data related to color. All sensor data may be included in the flavor sensor information, or any sensor data may not be included in the flavor sensor information.

The respective pieces of sensor data constituting the flavor sensor information are referred to as taste sensor data, olfactory sensor data, texture sensor data, sensible temperature sensor data, and color sensor data.

The taste sensor data is sensor data measured by the taste sensor. The taste sensor data includes at least one parameter of a saltiness sensor value, a sourness sensor value, a bitterness sensor value, a sweetness sensor value, an umami sensor value, a pungency sensor value, or an astringency sensor value.

Examples of the taste sensor include an artificial lipid membrane type taste sensor using an artificial lipid membrane as a sensor unit. The artificial lipid membrane type taste sensor is a sensor that detects a change in membrane potential caused by electrostatic interaction or hydrophobic interaction of a lipid membrane with a taste substance, which is a substance causing a taste to be sensed, and outputs the change as a sensor value.

Instead of the artificial lipid membrane type taste sensor, various devices such as a taste sensor using a polymer membrane can be used as the taste sensor as lone as the device can convert each element of saltiness, sourness, bitterness, sweetness, umami, pungency, and astringency constituting the taste of food into data and output the data.

The olfactory sensor data is sensor data measured by an olfactory sensor. The olfactory sensor data includes values for each element expressing an aroma, such as a hot aroma, a fruity aroma, a Grassy smell, a musty smell (cheesy), a citrus aroma, and a rose aroma.

As the olfactory sensor, for example, there is a sensor provided with an innumerable number of sensors such as crystal oscillators. The crystal oscillators will be used instead of human nose receptors An olfactory sensor using crystal oscillators detects a change in a vibration frequency of a crystal oscillator when an aroma component collides with the crystal oscillator, and outputs a value expressing the above-described aroma on the basis of a pattern of the change in the vibration frequency.

As long as it is a device capable of outputting a value expressing an aroma instead of a sensor using a crystal vibrator, it is possible to use, as an olfactory sensor, various devices using sensors including various materials such as carbon instead of a human nose receptor.

The texture sensor data is sensor data specified by analyzing an image captured by a camera or sensor data measured by various sensors. The texture sensor data includes at least one parameter of information indicating stiffness (hardness), stickiness, viscosity (stress), cohesiveness, polymer content, moisture content, oil content, and the like.

The hardness, stickiness, viscosity, and cohesiveness are recognized, for example, by analyzing an image obtained by capturing an image of an ingredient being cooked by the chef with a camera. For example, it is possible to recognize values such as hardness, stickiness, viscosity, and cohesiveness by analyzing an image of a soup stirred by the chef. These values may be recognized by measuring stress when the chef cuts an ingredient with a kitchen knife.

The polymer content, the moisture content, and the oil content are measured by, for example, a sensor that irradiates an ingredient with light having a predetermined wavelength and analyzes reflected light to measure these values.

A database in which each ingredient is associated with each parameter of texture may be prepared, and the texture sensor data of each ingredient may be recognized with reference to the database.

The sensible temperature sensor data is sensor data obtained by measuring the temperature of the ingredient with the temperature sensor.

The color sensor data is data specified by analyzing the color of the ingredient from an image captured by a camera.

2-2. Flavor Subjective Information

The flavor subjective information is information indicating how a person feels flavor subjectively, such as a chef who is cooking. The flavor subjective information is calculated on the basis of the flavor sensor information.

The flavor is formed by a taste, an aroma, a texture, a sensible temperature, and a color, and thus the flavor subjective information includes subjective information regarding a taste, subjective information regarding an aroma, subjective information regarding a texture, subjective information regarding a sensible temperature, and subjective information regarding a color. All of the subjective information regarding a taste, the subjective information regarding an aroma, the subjective information regarding a texture, the subjective information regarding a sensible temperature, and the subjective information regarding a color may be included in the flavor subjective information, or any of the subjective information may not be included in the flavor subjective information.

The respective pieces of subjective information constituting the flavor subjective information are referred to as taste subjective information, olfactory subjective information, texture subjective information, sensible temperature subjective information, and color subjective information.

FIG. 6 is a diagram illustrating a calculation example of the taste subjective information.

As illustrated in FIG. 6, the taste subjective information is calculated using a taste subjective information generation model which is a model of a neural network generated by deep learning or the like. The taste subjective information generation model is generated in advance by performing learning using, for example, taste sensor data of a certain ingredient and information (numerical value) indicating how the chef who has eaten the ingredient feels a taste.

For example, as illustrated in FIG. 6, in a case where each of a saltiness sensor value, a sourness sensor value, a bitterness sensor value, a sweetness sensor value, an umami sensor value, a pungency sensor value, and an astringency sensor value, which are taste sensor data of a certain ingredient, is input, each of a saltiness subjective value, a sourness subjective value, a bitterness subjective value, a sweetness subjective value, an umami subjective value, a pungency subjective value, and an astringency subjective value is output from the taste subjective information generation model.

The saltiness subjective value is a value representing how the chef teems saltiness. The sourness subjective value is a value representing how the chef feels sourness. Similarly, the bitterness subjective value, the sweetness subjective value, the umami subjective value, the pungency subjective value, and the astringency subjective value are values representing how the chef feels bitterness, sweetness, umami, pungency, and astringency, respectively.

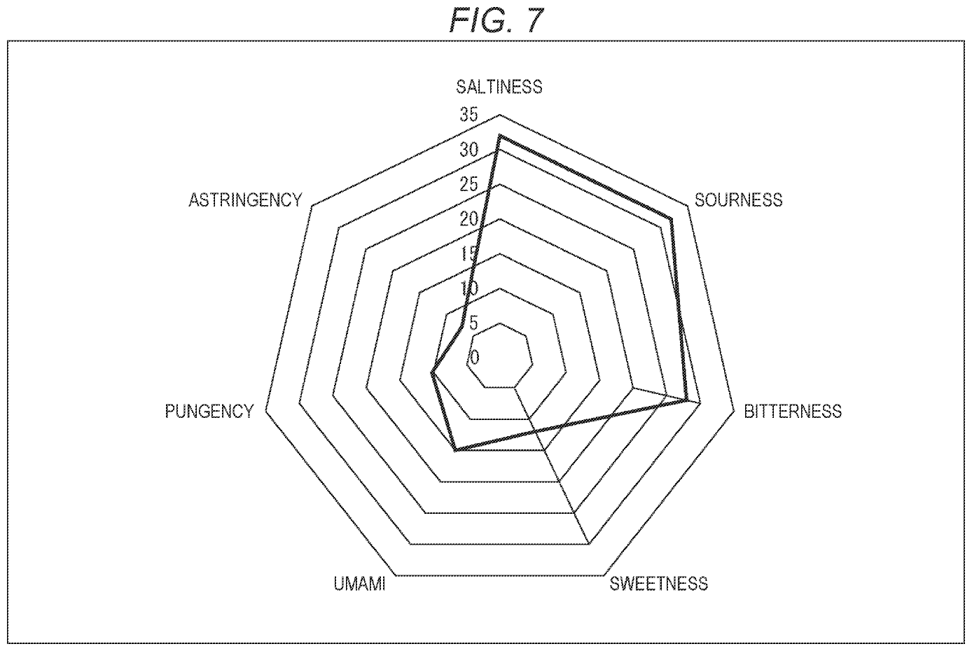

As illustrated in FIG. 7, the taste subjective information of a certain ingredient is represented as a chart by respective values of the saltiness subjective value, the sourness subjective value, the bitterness subjective value, the sweetness subjective value, an umami subjective value, the pungency subjective value, and the astringency subjective value. An ingredient having a similar shape of the chart of the taste subjective information is an ingredient having taste for the chef in a case where attention is paid only to the taste of the flavor.

Similarly, other subjective information constituting the flavor subjective information is calculated using each model for generating subjective information.

That is, the olfactory subjective information is calculated by inputting olfactory sensor data to an olfactory subjective information generation model, and the texture subjective information is calculated by inputting the texture sensor data to a texture subjective information generation model. The sensible temperature subjective information is calculated by inputting sensible temperature subjective sensor data to a sensible temperature subjective information generation model, and the color subjective information is calculated by inputting the color sensor data to a color subjective information generation model.

Instead of using the neural network model, the taste subjective information may be calculated on the basis of table information in which the taste sensor data of a certain ingredient is associated with information indicating how the chef who has eaten the ingredient feels a taste. Various methods can be employed as a method of calculating the flavor subjective information using the flavor sensor information.

As described above, the recipe data is formed by linking (associating) the cooking operation information, which is information regarding the cooking operation for achieving the cooking process, and the flavor information, which is information regarding the flavor of ingredients or a dish, measured in conjunction with the progress of the cooking process.

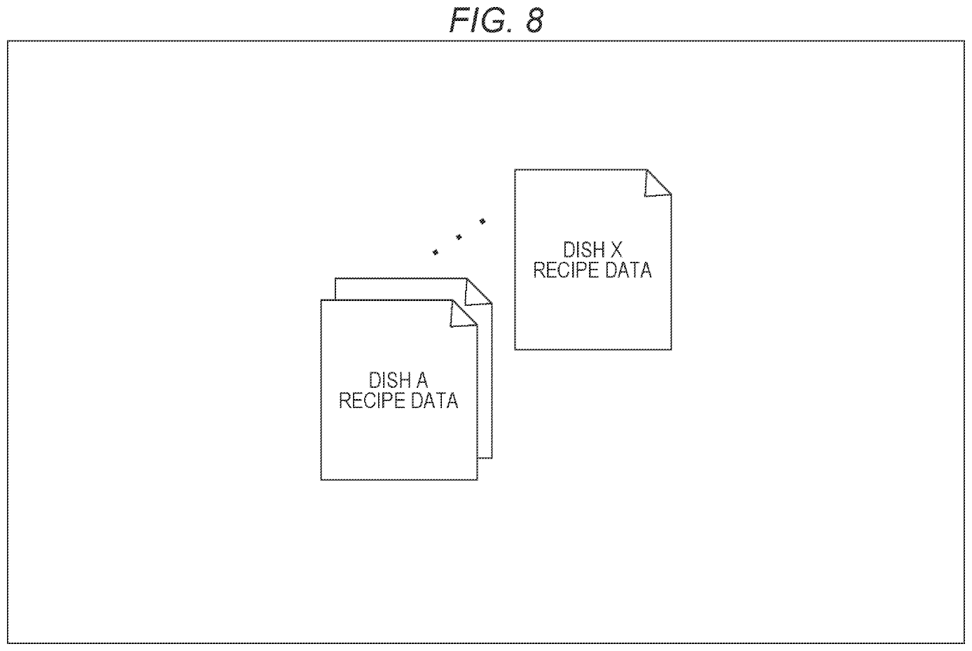

The recipe data including each piece of the information as described above is prepared for each dish as illustrated in FIG. 8. Which recipe data on the basis of which the dish is to be reproduced is selected by, for example, a person in a place where the cooking robot 1 is installed.

### EXAMPLE OF FLOWS OF GENERATION OF RECIPE DATA AND REPRODUCTION OF DISH

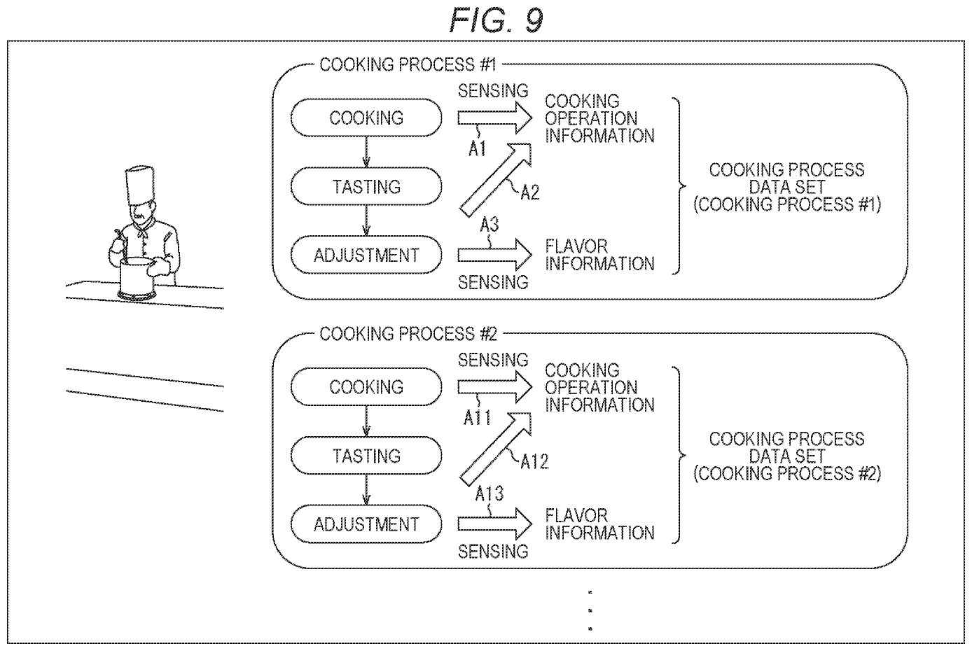

FIG. 9 .is a diagram illustrating an example of a flow of generating the recipe data.

As illustrated in FIG. 9, cooking by a chef is usually performed by repeating cooking using an ingredient, tasting the ingredient after cooking, and adjusting the flavor for each cooking process.

The flavor is adjusted by adding, with respect to the taste, for example, an operation such as adding salt in a case where saltiness is insufficient, or squeezing lemon juice in a case where sourness is insufficient. With respect to the aroma, for example, an operation such as chopping and adding herbs or cooking the ingredients is added. With respect to the texture, for example, in a case where the ingredient is hard, an operation such as softening by hitting or increasing the time for boiling is added.

The cooking operation information constituting the cooking process data set is generated on the basis of a sensing result obtained by sensing an operation of the chef to cook using the ingredients and an operation of the chef to adjust the flavor.

Furthermore, the flavor information is generated on the basis of a sensing result obtained by sensing the flavor of the ingredients after cooking.

In the example of FIG. 9, as indicated by arrows A1 and A2, the cooking operation information constituting the cooking process data set of the cooking process #1 is generated on the basis of sensing results of an operation of cooking performed by the chef as the cooking process #1 and an operation of the chef to adjust the flavor.

Furthermore, as indicated by an arrow A3, the flavor information constituting the cooking process data set of the cooking process #1 is generated on the basis of the sensing result of the flavor of the ingredient after cooking in the cooking process #1.

After the cooking process #1 is finished, the cooking process #2, which is the next cooking process, is performed.

Similarly, as indicated by arrows A11 and A12, the cooking operation information constituting the cooking process data set of the cooking process #2 is generated on the basis of sensing results of an operation of cooking performed by the chef as the cooking process #2 and an operation of the chef to adjust the flavor.

Furthermore, as indicated by an arrow A13, the flavor information constituting the cooking process data set of the cooking process #2 is generated on the basis of a sensing result of the flavor of the ingredient after cooking in the cooking process #2.

One dish is completed through such a plurality of cooking processes. Furthermore, the recipe data describing the cooking process data sets of the respective cooking processes is generated as the dish is completed.

Hereinafter, a case where one cooking process includes three cooking operations of cooking, tasting, and adjustment will be mainly described, but the unit of the cooking operation included in one cooking process can be arbitrarily set. One cooking process may include a cooking operation that does not involve tasting or adjustment of flavor after tasting, or may include only adjustment of flavor. In this case, similarly, the flavor is sensed for each cooking process, and the flavor information obtained on the basis of a sensing result is included in the cooking process data set.

The flavor sensing is not performed every time one cooking process is finished, and the timing of the flavor sensing can also be arbitrarily set. For example, the flavor sensing may be repeatedly performed during one cooking process. In this case, the cooking process data set includes time-series data of the flavor information.

Instead of including the flavor information in all the cooking process data sets, the flavor information may be included, every time the flavor is measured at an arbitrary timing, in the cooking process data set together with the information of a cooking operation performed at that timing.

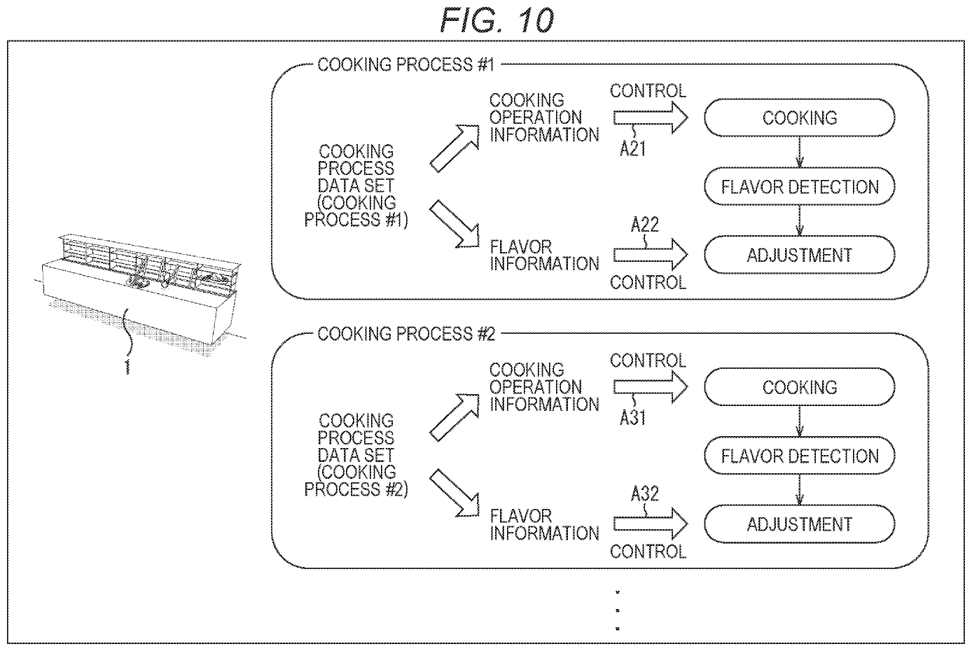

FIG. 10 is a diagram illustrating an example of a flow of reproduction of a dish based on the recipe data.

As illustrated in FIG. 10, reproduction of the dish by the cooking robot 1 is performed by repeating, for each cooking process, performing cooking on the basis of the cooking operation information included in the cooking process data set described in the recipe data, measuring the flavor of the ingredient after cooking, and adjusting the flavor.

The adjustment of the flavor is performed, for example, by applying an operation so that a flavor measured by a sensor prepared on the cooking robot 1 side approaches the flavor indicated by the flavor information. Details of the adjustment of the flavor by the cooking robot 1 will be described later.

The measurement and adjustment of the flavor may be repeated multiple times in one cooking process, for example. That is, every time the adjustment is performed, the flavor is measured for the ingredient after adjustment, and the flavor is adjusted on the basis of a measurement result.

In the example of FIG. 10, as indicated by an arrow A21, the cooking operation of the cooking robot 1 is controlled on the basis of the cooking operation information constituting the cooking process data set of the cooking process #1, and the same operation as the operation of the cooking process #1 of the chef is performed by the cooking robot 1.

After the cooking robot 1 performs the same operation as the operation of the cooking process #1 by the chef, the flavor of the ingredient after cooking is measured, and adjustment of the flavor of the cooking robot 1 is controlled on the basis of the flavor information. constituting the cooking process data set of the cooking process #1 as indicated by an arrow A22.

In a case where the flavor measured by the sensor prepared on the cooking robot 1 side matches the flavor indicated by the flavor information, the adjustment of the flavor is ended, and the cooking process #1 is also ended. For example, not only in the case where the flavor completely matches, but also in a case where the flavor measured by the sensor prepared on the cooking robot 1 side and the flavor indicated by the flavor information are similar by a threshold or more, it is determined that the two match.

After the cooking process #1 is finished, the cooking process #2, which is the next cooking process, is performed.

Similarly, as indicated by an arrow A31, the cooking operation of the cooking robot 1 is controlled on the basis of the cooking operation information constituting the cooking process data set of the cooking process #2, and the same operation as the operation of the cooking process #2 of the chef is performed by the cooking robot 1.

After the cooking robot 1 performs the same operation as the operation of the cooking process #2 by the chef, the flavor of the ingredient after cooking is measured, and adjustment of the flavor of the cooking robot 1 is controlled on the basis of the flavor information. constituting the cooking process data set of the cooking process #2 as indicated by an arrow A32.

In a case where the flavor measured by the sensor prepared on the cooking robot 1 side matches the flavor indicated by the flavor information, the adjustment of the flavor is ended, and the cooking process #2 is also ended.

Through such a plurality of cooking processes, the dish made by the chef is reproduced by the cooking robot 1.

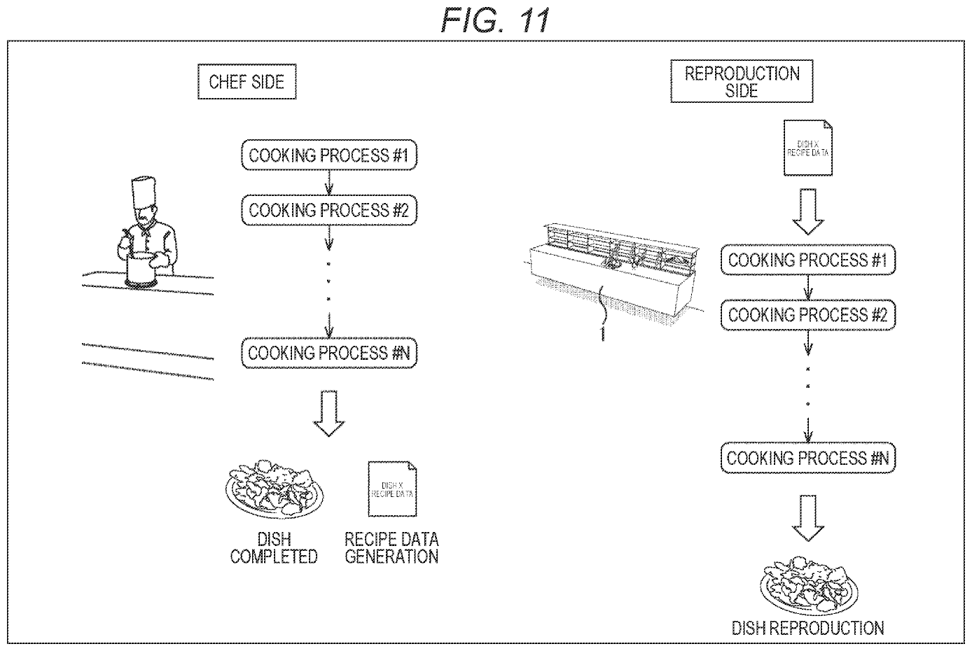

FIG. 11 is a diagram collectively illustrating the flow on the chef side and the flow on the reproduction side.

As illustrated on the left side of FIG. 11, one dish is completed through a plurality of cooking processes of cooking processes #1 to #N, and the recipe data describing the cooking process data sets of the respective cooking processes is generated.

On the other hand, on the reproduction side, one dish is reproduced through a plurality of cooking processes of cooking processes #1 to #N, which are the same as the cooking processes performed on the chef side, on the basis oi the recipe data generated by cooking by the chef.

Since the cooking by the cooking robot 1 is performed by adjusting the flavor for each cooking process, the finally completed dish is a dish having the same or close flavor as the dish made by the chef. In this manner, a dish having the same flavor as the dish made by the chef is reproduced on the basis of the recipe data with high reproducibility.

For example, the chef can provide a dish having the same flavor as the dish that he or she has made to a person who cannot visit the restaurant that he or she manages. Furthermore, the chef can leave the dish that he or she makes as the recipe data in a reproducible form.

On the other hand, a person who eats the dish reproduced by the cooking robot 1 can eat a dish having the same flavor as the dish made by the chef.

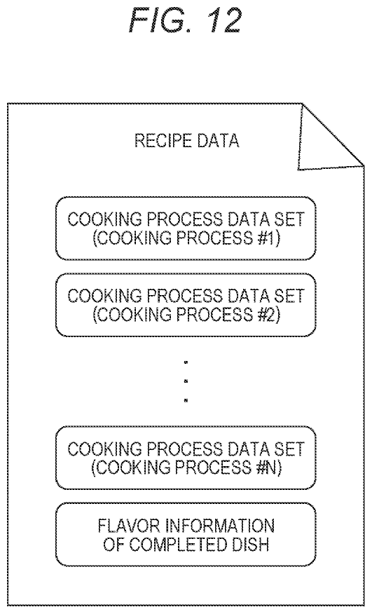

FIG. 12 is a diagram illustrating an example of other description contents of the recipe data.

As illustrated in FIG. 12, the flavor information regarding the flavor of a completed dish may be included in the recipe data in this case, the flavor information regarding the flavor of the completed dish is linked to the entire cooking operation information.

Thus, the association relationship between the cooking operation information and the flavor information does not need to be one-to-one.

### CONFIGURATION EXAMPLE OF COOKING SYSTEM

(1) Overall Configuration

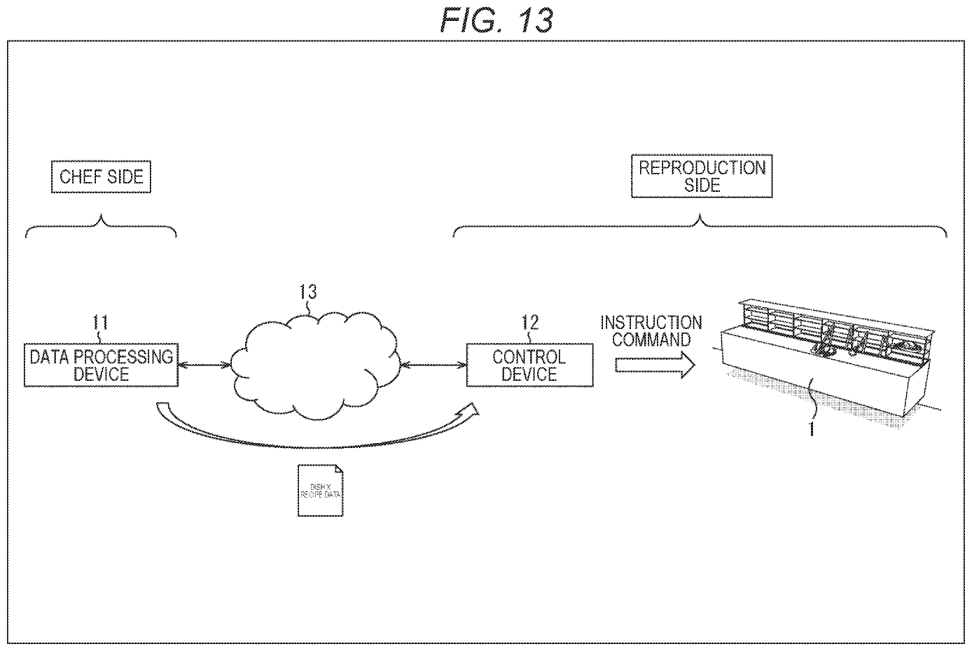

FIG. 13 is a diagram illustrating a configuration example of a cooking system according to the one embodiment of the present technology.

As illustrated in FIG. 13, the cooking system is configured by connecting a data processing device 11 provided as a configuration on the chef side and a control device 12 provided as a configuration on the reproduction side via a network 13 such as the Internet. As described above, the cooking system is provided with a plurality of such configurations on the chef side and a plurality of such configurations on the reproduction side.

The data processing device 11 is a device that generates the above-described recipe data. The data processing device 11 includes a computer or the like. The data processing device 11 transmits, for example, the recipe data of a dish selected by a person who eats the reproduced dish to the control device 12 via the network 13.

The control device 12 is a device that controls the cooking robot 1. The control device 12 also includes a computer or the like. The control device 12 receives the recipe data provided from the data processing device 11 and outputs an instruction command on the basis of the description of the recipe data, thereby controlling the cooking operation of the cooking robot 1.

The cooking robot 1 drives each unit such as a cooking arm according to the instruction command supplied from the control device 12, and performs the cooking operation of each cooking process. The instruction command includes information for controlling torque, a driving direction, and a driving amount of a motor provided in the cooking arm, and the like.

Until the dish is completed, instruction commands are sequentially output from the control device 12 to the cooking robot 1. The cooking robot 1 performs an operation corresponding to the instruction command, and the dish is finally completed.

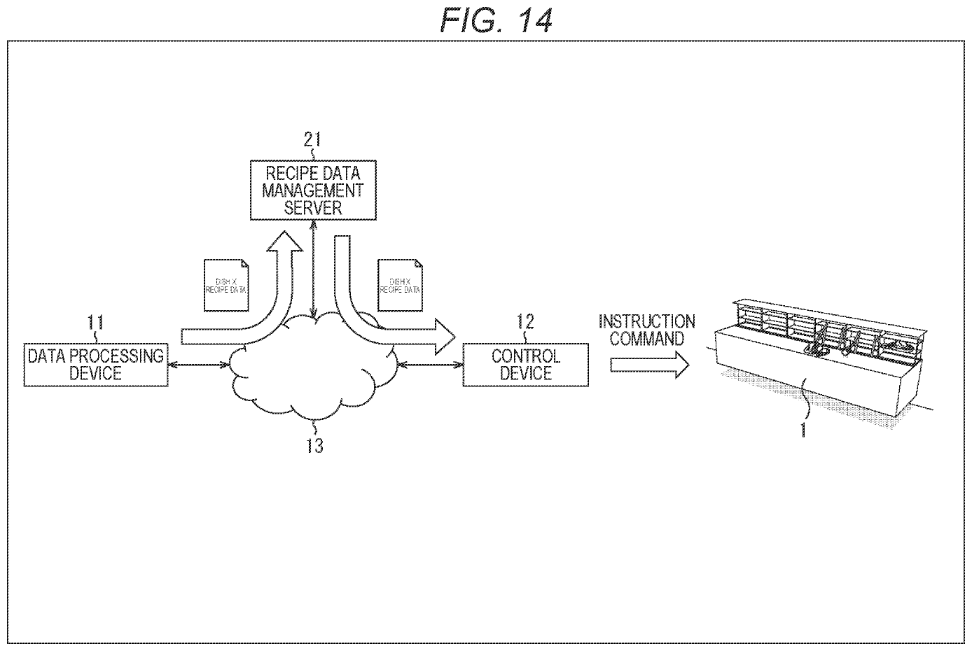

FIG. 14 is a diagram illustrating another configuration example of the cooking system.

As illustrated in FIG. 14, the recipe data may be provided from the chef side to the reproduction side via a server on the network.

A recipe data management server 21 illustrated in FIG. 14 receives the recipe data transmitted from each of the data processing devices 11, and manages the recipe data by storing in a database, and the like. The recipe data management server 21 transmits predetermined recipe data to the control device 12 in response to a request from the control device 12 made via the network 13.

The recipe data management server 21 has a function of centrally managing recipe data of dishes made by chefs of various restaurants and delivering the recipe data in response to a request from the reproduction side.

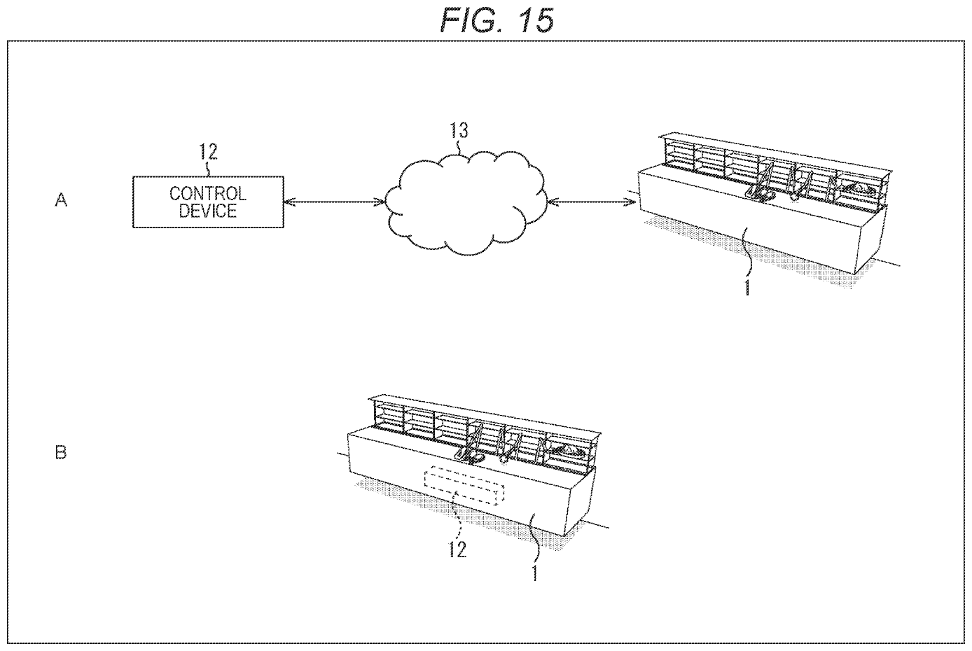

FIG. 15 is a diagram illustrating an arrangement example of the control device 12.

As illustrated in A of FIG. 15, the control device 12 is provided as, for example, a device outside the cooking robot 1. In the example of A of FIG. 15, the control device 12 and the cooking robot 1 are connected via the network 13.

The instruction command. transmitted from the control device 12 is received by the cooking robot 1 via the network 13. Various kinds of data such as an image captured by the camera of the cooking robot 1 and sensor data measured by the sensor provided in the cooking robot 1 are transmitted from the cooking robot 1 to the control device 12 via the network 13.

Instead of connecting one cooking robot 1 to one control device 12, a plurality of cooking robots 1 may be connected to one control device 12.

As illustrated in B of FIG. 15, the control device 12 may be provided inside a housing of the cooking robot 1. In this case, operation of each unit of the cooking robot 1 is controlled according to an instruction command generated by the control device 12.

Hereinafter, it is mainly described that the control device 12 is provided as a device outside the cooking robot 1.

(2) Configuration on Chef Side

(2-1) Configuration around Kitchen

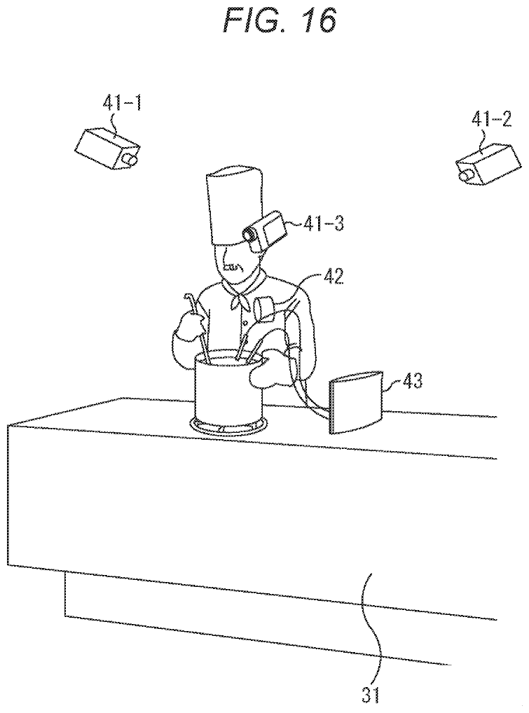

FIG. 16 is a diagram illustrating a configuration example around a kitchen where the chef performs cooking.

Various devices for measuring information used for analysis of operation of the chef and analysis of flavor of ingredients are provided around the kitchen 31 where the chef cooks. Some of these devices are attached to the body of the chef.

The devices provided around the kitchen 31 are each connected to the data processing device 11 via wired or wireless communication. Each device provided around the kitchen 31 may be connected to the data processing device 11 via a network.

As illustrated in FIG. 16, cameras 41-1 and 41-2 are provided above the kitchen 31. The cameras 41-1 and 41-2 capture images of the state of the chef who is cooking and the state on a top board of the kitchen 31, and transmit the images obtained by the capturing to the data processing device 11.

A small camera 41-3 is attached to the head of the chef. The image-capturing range of the camera 41-3 is switched according to the direction of the line-of-sight of the chef. The camera 41-3 captures images of the state of hands of the chef who is cooking, the state of an ingredient to be cooked, and the state on the top board of the kitchen 31, and transmits the images obtained by the capturing to the data processing device 11.

In this manner, a plurality of cameras is provided around the kitchen 31. In a case where it is not necessary to distinguish the cameras 41-1 to 41-3, the cameras are collectively referred to as a camera 41 as appropriate.

An olfactory sensor 42 is attached to the upper body of the chef. The olfactory sensor 42 measures an aroma of the ingredient and transmits olfactory sensor data to the data processing device 11.

A taste sensor 43 is provided on the top board of the kitchen 31. The taste sensor 43 measures a taste of the ingredient and transmits taste sensor data to the data processing device 11.

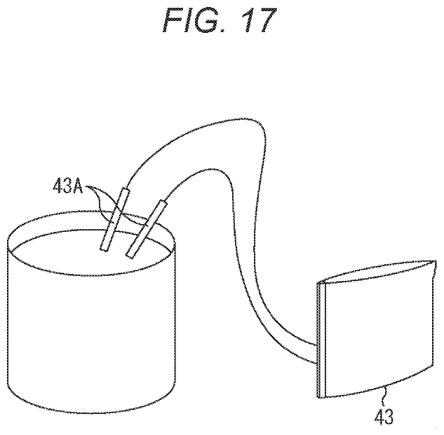

As illustrated in FIG. 17, the taste sensor 43 is used by bringing a sensor unit 43A provided at a tip of a cable into contact with the ingredient or the like to be cooked. In a case where the taste sensor 43 is the above-described artificial lipid membrane type taste sensor, a lipid membrane is provided in the sensor unit 43A.

Not only the taste sensor data but also the texture sensor data and the sensible temperature sensor data among the sensor data constituting the flavor sensor information. may be measured by the taste sensor 43 and transmitted to the data processing device 11. In this case, the taste sensor 43 is provided with functions as a texture sensor and a sensible temperature sensor. For example, texture sensor data such as polymer content, moisture content, and oil content is measured by the taste sensor 43.

Various devices other than the devices illustrated in FIG. 16 are provided around the kitchen 31.

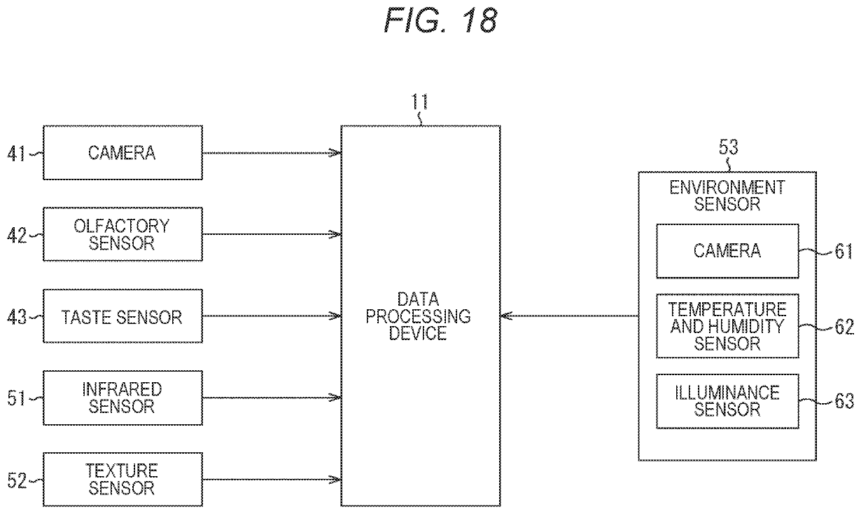

FIG. 18 is a block diagram illustrating a configuration example on the chef side.

Among components illustrated in FIG. 18, the same components as those described above are denoted by the same reference numerals. Duplicate descriptions will be omitted as appropriate.

As illustrated in FIG. 1$, the camera 41, the olfactory sensor 42, the taste sensor 43, an infrared sensor 51, a texture sensor 52, and an environment sensor 53 are connected to the data processing device 11. The same components as those described above are denoted by the same reference numerals. Duplicate descriptions will be omitted as appropriate.

The infrared sensor 51 outputs IR light and generates an IR image. The IR image generated by the infrared sensor 51 is output to the data processing device 11. Various analyses of the operation of the chef, ingredients, and the like may be performed on the basis of the IR image captured by the infrared sensor 51 instead of the image (RGB image) captured by the camera 41.

The texture sensor 52 includes sensors that output various types of sensor data used for texture analysis, such as a hardness sensor, a stress sensor, a moisture content sensor, and a temperature sensor. The hardness sensor, the stress sensor, the moisture content sensor, and the temperature sensor may be provided in a cooking tool such as a kitchen knife, a frying pan, or an oven.

Sensor data measured by the texture sensor 52 is output to the data processing device 11.

The environment sensor 53 is a sensor that measures a cooking environment that is an environment of a space such as a kitchen where a chef performs cooking. In the example of FIG. 18, the environment sensor 53 includes a camera 61, a temperature and humidity sensor 62, and an illuminance sensor 63.

The camera 61 outputs an image obtained by capturing a cooking space to the data processing device 11. By analyzing the image obtained by capturing the cooking space, for example, color (lightness, hue, and saturation) of the cooking space is measured.

The temperature and humidity sensor 62 measures the temperature and humidity of the space on the chef side, and outputs information indicating a measurement result to the data processing device 11.

The illuminance sensor 63 measures brightness of the space on the chef side, and outputs information indicating a measurement result to the data processing device 11.

The color, temperature, and brightness of the space in which a dish is eaten affect how people feel the flavor. For example, in consideration of the flavor of the same dish, a lighter taste is preferred as the temperature is higher, and a richer taste is preferred as the temperature is lower.

Such a cooking environment that may affect how a person feels the flavor may be measured at the time of cooking and included in the recipe data as environment information.

On the reproduction side, the environment such as the color, temperature, and brightness of the room where the person who eats the dish is present is adjusted to be the same as the cooking environment indicated by the environment information included in the recipe data.

Thus, how the flavor is felt when the reproduced dish is eaten can be made closer to how the flavor is felt at the time of cooking by the chef.

Various types of information that may affect how the flavor is felt, such as air pressure and noise of the space on the chef side, the season at the time of cooking, and the time zone, may be measured by the environment sensor 53 and included in the recipe data as the environment information.

(2-2) Configuration of Data Processing Device 11

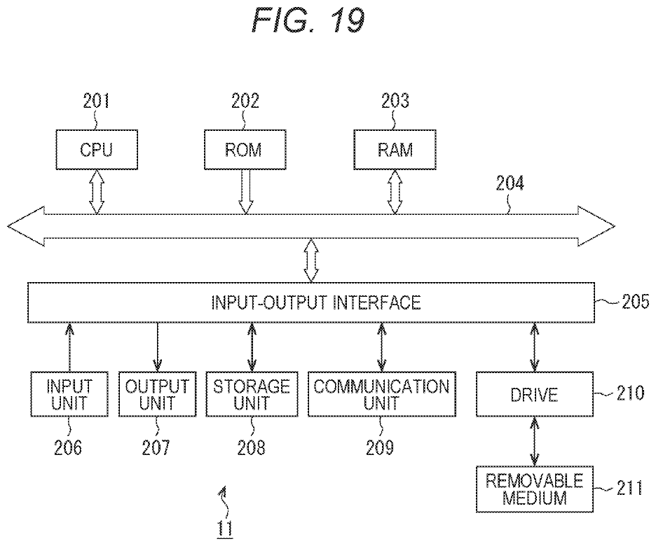

FIG. 19 is a block diagram illustrating a configuration example of hardware of the data processing device. 11.

As illustrated in FIG. 19, the data processing device 11 includes a computer. A central processing unit (CPU) 201, a read only memory (ROM) 202, and a random access memory (RAM) 203 are interconnected via a bus 204.

An input-output interface 205 is further connected to the bus 204. An input unit 206 including a keyboard, a mouse, and the like, and an output unit 207 including a display, a speaker, and the like are connected to the input-output interface 205.

Furthermore, the input-output interface 205 is connected to a storage unit 208 including a hard disk and a non-volatile memory and the like, a communication unit 209 including a network interface and the like, and a drive 210 that drives a removable medium 211.

In the computer configured as described above, for example, the CPU 201 loads a program stored in the storage unit 208 into the RAM 203 via the input-output interface 205 and the bus 204 and executes the program, to thereby perform various processes.

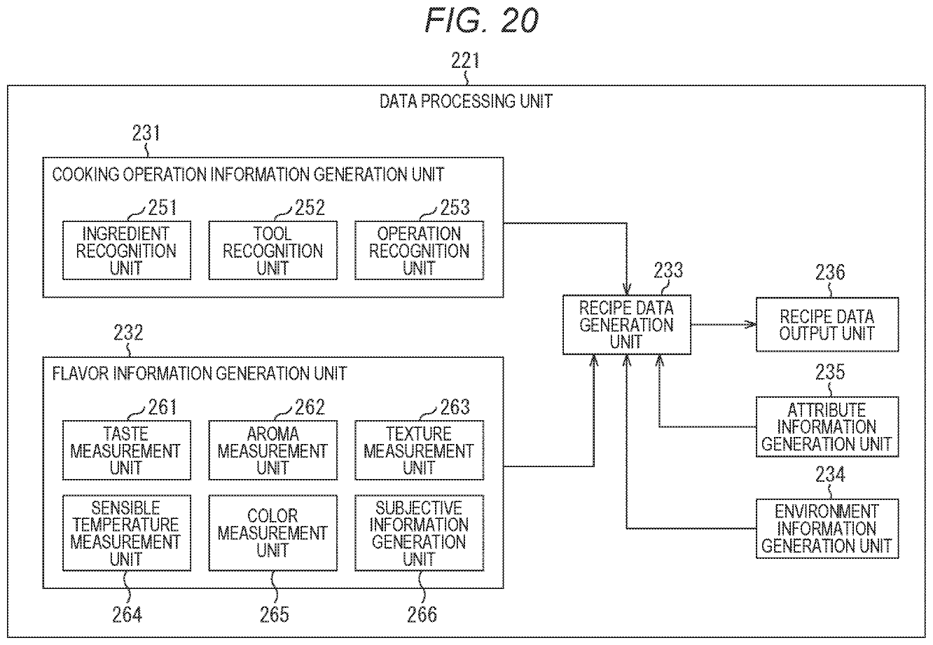

FIG. 20 is a block diagram illustrating a functional configuration example of the data processing device 11.

At least a part of the functional units illustrated in FIG. 20 is implemented by executing a predetermined program by the CPU 201 in FIG. 19.

As illustrated in FIG. 20, a data processing unit 221 is implemented in the data processing device 11. The data processing unit 221 includes a cooking operation information generation unit 231, a flavor information generation unit 232, a recipe data generation unit 233, an environment information generation unit 234, an attribute information generation unit 235, and a recipe data output unit 236.

The cooking operation information generation unit 231 includes an ingredient recognition unit 251, a tool recognition unit 252, and an operation recognition unit 253.

The ingredient recognition unit 251 analyzes an image captured by the camera 41 and recognizes the type of ingredient used by the chef for cooking. Recognition information for use in recognition of types of various ingredients such as feature information is given to the ingredient recognition unit 251.

The tool recognition unit 252 analyzes the image captured by the camera 41 and recognizes the type of cooking tool used by the chef for cooking. Recognition information for use in recognition of types of various cooking tools is given to the tool recognition unit 252.

The operation recognition unit 253 analyzes an image captured by the camera 41, sensor data representing a measurement result of a sensor attached to the body of the chef, and the like, and recognizes the operation of the chef who performs cooking.

Information indicating a recognition result by each unit of the cooking operation information generation unit 231 is supplied to the recipe data generation unit 233.

The flavor information generation unit 232 includes a taste measurement unit 261, an aroma measurement unit 262, a texture measurement unit 263, a sensible temperature measurement unit 264, a color measurement unit 265, and a subjective information generation unit 266.

The taste measurement unit 261 measures a taste of an ingredient by controlling the taste sensor 43, and acquires the taste sensor data. Ingredients to be measured include all foods handled by the chef, such as an ingredient before cooking, an ingredient after cooking, and a completed dish.

The aroma measurement unit 262 measures an aroma of an ingredient by controlling the olfactory sensor 42, and acquires olfactory sensor data of the ingredient.

The texture measurement unit 263 measures texture of an ingredient by analysing an image captured by the camera 41 or a measurement result by the texture sensor 52, or the like, and acquires the texture sensor data of the ingredient.

The sensible temperature measurement unit 264 acquires the sensible temperature sensor data indicating a sensible temperature of an ingredient measured by a temperature sensor.

The color measurement unit 265 recognizes a color of an ingredient by analyzing an image captured by the camera 41, or the like, and acquires the color sensor data indicating a recognition result. In a case where a recognition target of color is a dish completed by serving ingredients, the color of each portion in the entire dish is recognized.

The subjective information generation unit 266 generates the subjective information on the basis of sensor data acquired by the respective units of the taste measurement unit 261 to the color measurement unit 265. The subjective information generation unit 266 performs processing of converting objective data regarding the flavor represented by the sensor data into subjective data indicating how the chef feels the flavor.

Information used for generation of the subjective information, such as the neural network described with reference to FIG. 6, is given to the subjective information generation unit 266.

For example, the subjective information generation unit 266 inputs the taste sensor data acquired by the taste measurement unit 261 to the taste subjective information generation model, and generates the taste subjective information of the ingredient.

Similarly, the subjective information generation unit 266 inputs the olfactory sensor data acquired by the aroma measurement unit 262 to the olfactory subjective information generation model, and generates the olfactory subjective information of the ingredient. The subjective information generation unit 266 inputs the texture sensor data acquired by the texture measurement unit 263 to the texture subjective information generation model, and generates the texture subjective information of the ingredient.

The subjective information generation unit 266 inputs the sensible temperature sensor data acquired by the sensible temperature measurement unit 264 to the sensible temperature subjective information generation model, and generates the sensible temperature subjective information of the ingredient. The subjective information generation unit 266 inputs the color sensor data acquired by the color measurement unit 265 to the color subjective information generation model, and generates the color subjective information of the ingredient.

The sensor data acquired by each of the taste measurement unit 261 to the color measurement unit 265 and the respective pieces of subjective information generated by the subjective information generation unit 266 are supplied to the recipe data generation unit 233.

The recipe data generation unit 233 generates cooking operation information on the basis of information supplied from each unit of the cooking operation information generation unit 231. That is, the recipe data generation unit 233 generates the ingredient information on the basis of a recognition result by the ingredient recognition unit 251, and generates the operation information on the basis of recognition results by the tool recognition unit 252 and the operation recognition unit 253. The recipe data generation unit 233 generates the cooking operation information including the ingredient information and the operation information.

Furthermore, the recipe data generation unit 233 also generates the flavor information on the basis of information supplied from each unit of the flavor information generation unit 232. That is, the recipe data generation unit 233 generates the flavor sensor information on the basis of the sensor data acquired by the taste measurement unit 261 to the color measurement unit 265, and generates the flavor subjective information on the basis of the subjective information generated by the subjective information generation unit 266. The recipe data generation unit 233 generates the flavor information including the flavor sensor information and the flavor subjective information.

The recipe data generation unit 233 generates the cooking process data set by associating the cooking operation information with the flavor information for each cooking process of the chef, for example. The recipe data generation unit 233 generates the recipe data describing a plurality of cooking process data sets by integrating cooking process data sets associated with respective cooking processes from a first cooking process to a last cooking process of a certain dish.

The recipe data generation unit 233 outputs the recipe data generated in this manner to the recipe data output unit 236. The recipe data output by the recipe data generation unit 233 appropriately includes the environment information generated by the environment information generation unit 234 and the attribute information generated by the attribute information generation unit 235.

The environment information generation unit 234 generates the environment information indicating the cooking environment on the basis of a measurement result of the environment sensor 53. The environment information generated by the environment information generation unit 234 is output to the recipe data generation unit 233.

The attribute information generation unit 235 generates attribute information indicating attributes of the chef. The attributes of the chef include, for example, the age, gender, nationality, and living area of the chef. Information indicating a physical condition and the like of the chef may be included in the attribute information.

The age, sex, nationality, and living area of the chef affect how the flavor is felt. That is, it is considered that the flavor subjective information included in the recipe data is affected by the age, sex, nationality, living area, and the like of the chef.

On the reproduction side, in a case where processing is performed using the flavor subjective information included in the recipe data, the flavor subjective information is appropriately corrected according to differences between the attributes of the chef indicated by the attribute information and the attributes of the person who eats the reproduced dish, and the processing is performed using the corrected flavor subjective information.

For example, it is assumed that the chef is French and the person who eats the reproduced dish is Japanese. In this case, how the chef feels the flavor indicated by the flavor subjective information included in the recipe data is how French people feel the flavor, and is different from how Japanese people feel the flavor.

The flavor subjective information included in the recipe data is corrected on the basis of information indicating how Japanese people feel corresponding to how French people feel so that the same flavor can be felt even when the Japanese person eats. The information used to correct the flavor subjective information is information in which how French people feel and how Japanese people feel are associated with each flavor, and is statistically generated, for example, and is prepared in advance on the reproduction side.

Attributes such as a category of dishes made by the chef, such as French dish, Japanese dish, Italian dish, and Spanish dish, may be included in the attribute information.

Furthermore, the attribute of an ingredient or seasoning used for cooking may be included in the attribute information. The attribute of an ingredient includes a production area, a variety, and the like. The attribute of seasoning also includes a production area, a variety, and the like.

Thus, the recipe data may include cook attribute information that is attribute information indicating the attributes of the chef, food attribute information that is attribute information indicating the attribute of a dish or an ingredient, and seasoning attribute information that is attribute information indicating the attributes of seasoning among ingredients.

The recipe data output unit 236 controls the communication unit 209 (FIG. 19) and outputs the recipe data generated by the recipe data generation unit 233. The recipe data output from the recipe data output unit 236 is supplied to the control device 12 or the recipe data management server 21 via the network 13.

(3) Configuration on Reproduction Side

(3-1) Configuration of Cooking Robot 1

Appearance of Cooking Robot 1

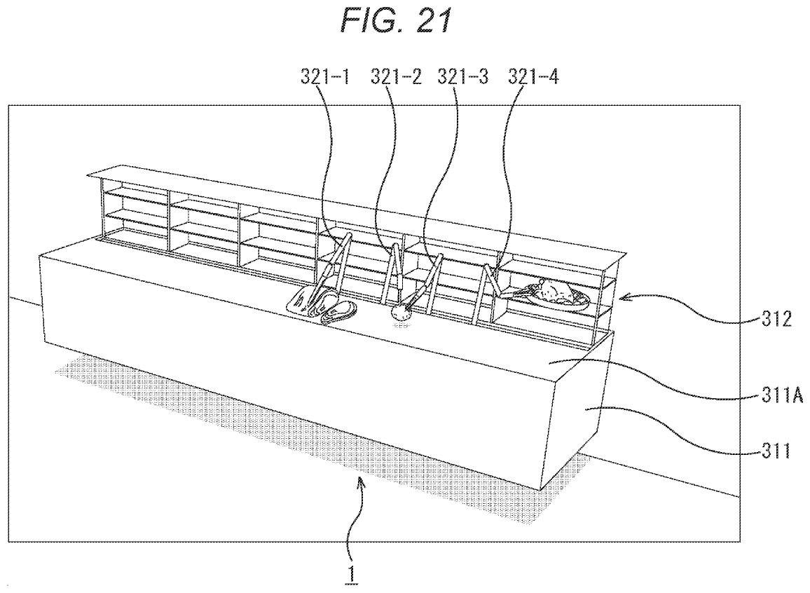

FIG. 21 is a perspective view illustrating an appearance of the cooking robot 1.

As illustrated in FIG. 21, the cooking robot 1 is a kitchen type robot having a housing 311 having a horizontally long rectangular parallelepiped shape. Various configurations are provided inside the housing 311 which is a main body of the cooking robot 1.

A cooking assistance system 312 is provided on the back side of the housing 311 so as to stand upright from the upper surface of the housing 311. Each space formed in the cooking assistance system 312 by being divided by a thin plate-shaped member has a function for assisting cooking by cooking arms 321-1 to 321-4, such as a refrigerator, an oven range, and storage.

A rail is provided on the top board 311A in a longitudinal direction, and the cooking arms 321-1 to 321-4 are provided on the rail. The cooking arms 321-1 to 321-4 can be changed in position along the rail as a movement mechanism.

The cooking arms 321-1 to 321-4 are robot arms formed by connecting cylindrical members by joint parts. Various operations related to cooking are performed by the cooking arms 321-1 to 321-4.

A space above the top board 311A is a cooking space in which the cooking arms 321-1 to 321-4 perform cooking.

Although four cooking arms are illustrated in FIG. 21, the number of cooking arms is not limited to four. Hereinafter, in a case where it is not necessary to distinguish each of the cooking arms 321-1 to 321-4 as appropriate, they are collectively referred to as a cooking arm 321.

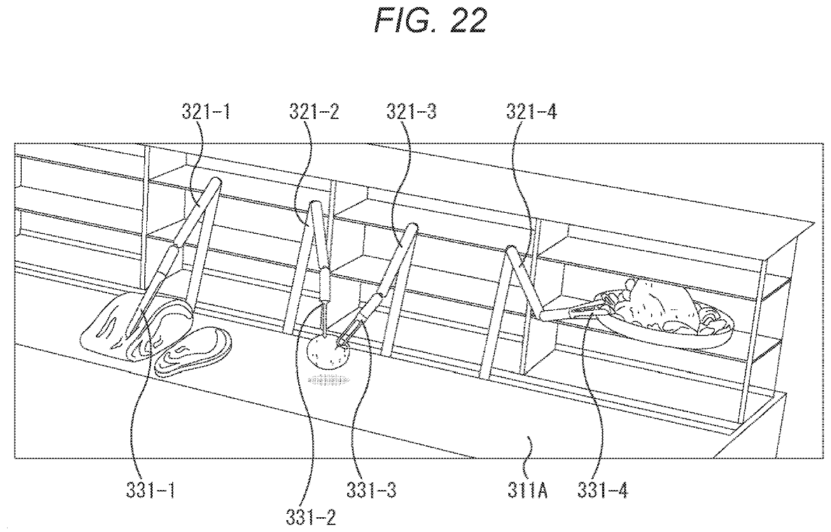

FIG. 22 is an enlarged view illustrating a state of the cooking arms 321.

As illustrated in FIG. 22, an attachment having various cooking functions is attached to a distal end of the cooking arm 321. As the attachment for the cooking arm 321, various attachments such as an attachment having a manipulator function (hand function) of gripping an ingredient, a dish, or the like, and an attachment having a knife function of cutting an ingredient are prepared.

In the example of FIG. 22, a knife attachment 331-1, which is an attachment having a knife function, is attached to the cooking arm 321-1. A lump of meat placed on the top board 311A is cut using the knife attachment 331-1.

A spindle attachment 331-2, which is an attachment used to fix the ingredient or rotate the ingredient, is attached to the cooking arm 321-2.

A peeler attachment 331-3, which is an attachment having a peeler function of peeling off the skin of the ingredient, is attached to the cooking arm 321-3.

The skin of a potato lifted by the cooking arm 321-2 using the spindle attachment. 331-2 is peeled off by the cooking arm 321-3 using the peeler attachment 331-3. In this manner, the plurality of cooking arms 321 can cooperate to perform one operation.

A manipulator attachment 331-4, which is an attachment having a manipulator function, is attached to the cooking arm 321-4. A frying pan with chicken is brought into a space of the cooking assistance system 312 having an oven function by using the manipulator attachment 331-4.

Such cooking by the cooking arm 321 proceeds by appropriately replacing the attachment according to the content of operation. The attachment is automatically replaced by, for example, the cooking robot 1.

It is also possible to attach the same attachment to the plurality of cooking arms 321, such as attaching the manipulator attachment 331-4 to each of the four cooking arms 321.

The cooking by the cooking robot 1 is not only, performed using the attachment as described above prepared as a tool for the cooking arm, but also appropriately performed using the same tool as a tool used by a person for cooking. For example, a knife used by a person is grasped by the manipulator attachment 331-4, and cooking such as cutting of an ingredient is performed using the knife.

Configuration of Cooking Arm

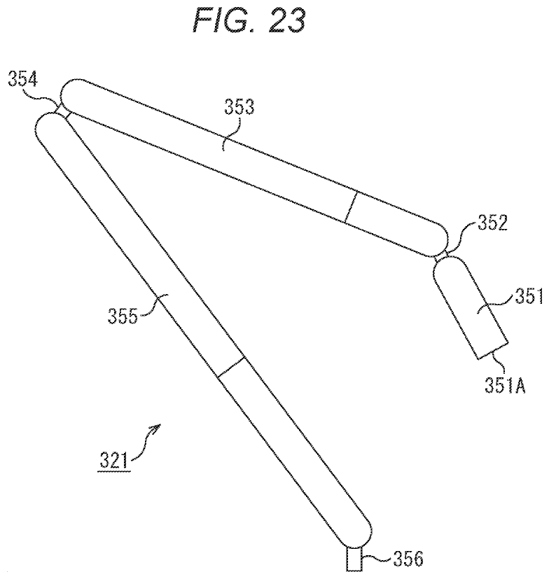

FIG. 23 is a view illustrating an appearance of the cooking arm 321.

As illustrated in FIG. 23, the cooking arm 321 is generally formed by connecting thin cylindrical members with hinge parts serving as joint parts. Each hinge part is provided with a motor or the like that generates a force for driving each member.

As the cylindrical member, an attachment-detachment member 351, a relay member 353, and a base member 355 are provided in order from the distal end. The attachment-detachment member 351 is a member having a length of approximately ⅕ of the length of the relay member 353. The total length of the attachment-detachment member 351 and the relay member 353 is substantially the same as the length of the base member 355.

The attachment-detachment member 351 and the relay member 353 are connected by a hinge part 352, and the relay member 353 and the base member 355 are connected by a hinge part 354. The hinge part 352 and the hinge part 354 are provided at both ends of the relay member 353.

In this example, the cooking arm 321 includes three cylindrical members, but may include four or more cylindrical members. In this case, a plurality of relay members 353 is provided.

An attachment-detachment part 351A to and from which an attachment is attached or detached is provided at a distal end of the attachment-detachment member 351. The attachment-detachment member 351 has the attachment-detachment part 351A to and from which one of various attachments is attached or detached, and functions as a cooking function arm unit that performs cooking by operating the attachment.

An attachment-detachment part 356 to be attached to the rail is provided at a rear end of the base member 355. The base member 355 functions as a moving function arm unit that achieves movement of the cooking arm 321.

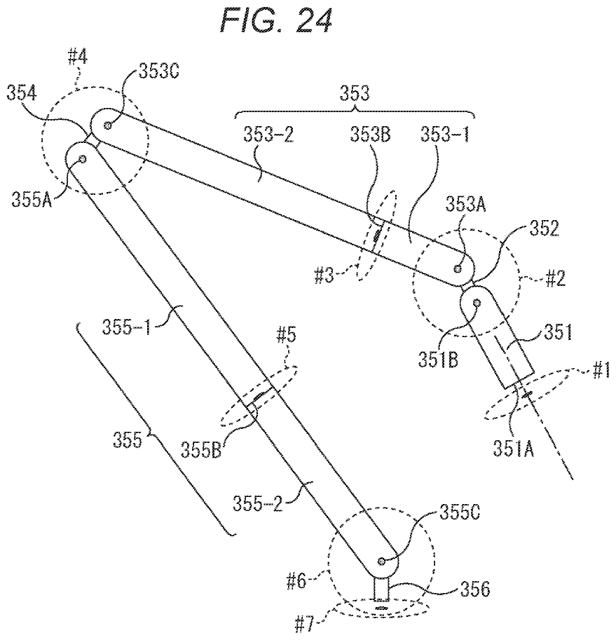

FIG. 24 is a diagram illustrating an example of a movable range of each part of the cooking arm 321.

As indicated by an ellipse #1, the attachment-detachment member 351 is rotatable about a central axis of a circular cross section. A flat small circle illustrated at the center of the ellipse #1 indicates a direction of a rotation axis of an alternate long and short dash line.

As indicated by a circle #2, the attachment-detachment member 351 is rotatable about an axis passing through a fitting part 351E with the hinge part 352. Further, the relay member 353 is rotatable about an axis passing through a fitting part 353A with the hinge part 352.

Two small circles illustrated inside the circle #2 indicate directions of respective rotation axes (directions perpendicular to the paper surface). Each of the movable range of the attachment-detachment member 351 about the axis passing through the fitting part 351B and the movable range of the relay member 353 about the axis passing through the fitting part 353A is, for example, a range of 90 degrees.

The relay member 353 is configured separately by a member 353-1 on a distal end side and a member 353-2 on the rear end side. As indicated by an ellipse #3, the relay member 353 is rotatable about a central axis of a circular cross section in a connecting part 353B between the member 353-1 and the member 353-2.

The other movable parts basically have similar movable ranges.

That is, as indicated by a circle 44, the relay member 353 is rotatable about an axis passing through a fitting part 353C with the hinge part 354. Furthermore, the base member 355 is rotatable about an axis passing through a fitting part 355A with the hinge part 354.

The base member 355 is configured to be separated by a member 355-1 on the distal end side and a member 355-2 on the rear end side. As indicated by an ellipse 45, the base member 355 is rotatable about a central axis of a circular cross section in a connecting part 355B between the member 355-1 and the member 355-2.

As indicated by a circle #6, the base member 355 is rotatable about an axis passing through a fitting part 355C with the attachment-detachment part 356.

As indicated by an ellipse 47, the attachment-detachment part 356 is attached to the rail so as to be rotatable about the central axis of the circular cross section.

Thus, each of the attachment-detachment member 351 having the attachment-detachment part 351A at the distal end, the relay member 353 connecting the attachment-detachment member 351 and the base member 355, and the base member 355 to which the attachment-detachment part 356 is connected at the rear end is rotatably connected by the hinge parts. The movement of each movable part is controlled by a controller in the cooking robot 1 according to an instruction command.

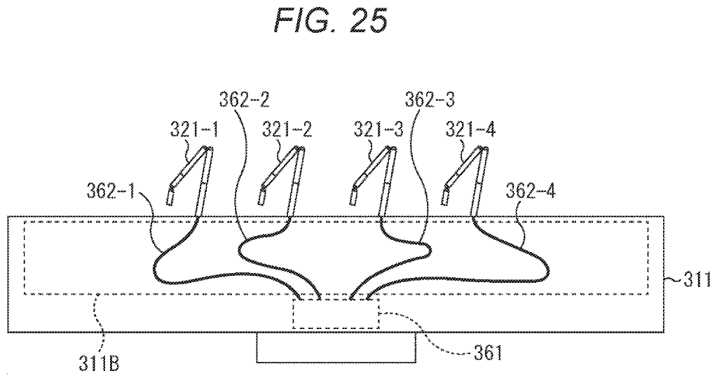

FIG. 25 is a diagram illustrating an example of connection between the cooking arms and the controller.

As illustrated in FIG. 25, the cooking arms 321 and a controller 361 are connected via wirings in a space 311B formed inside the housing 311. In the example of

FIG. 25, the cooking arms 321-1 to 321-4 and the controller 361 are connected via wirings 362-1 to 362-4, respectively. The wirings 362-1 to 362-4 having flexibility are appropriately bent according to positions of the cooking arms 321-1 to 321-4.

Thus, the cooking robot 1 is a robot capable of performing various operations related to cooking by driving the cooking arms 321.

Configuration around Cooking Robot 1

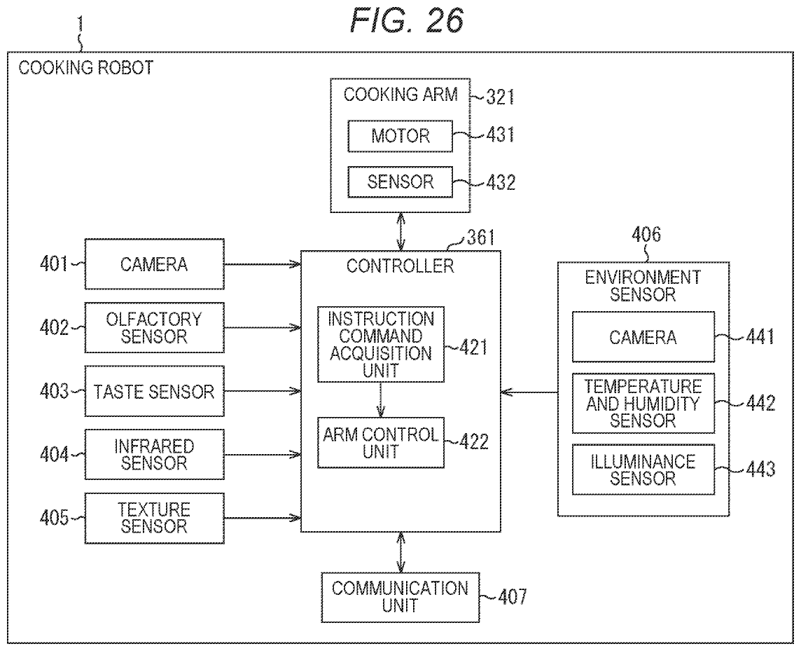

FIG. 26 is a block diagram illustrating an example of a configuration of the cooking robot 1 and surroundings.

The cooking robot 1 is configured by connecting each unit to the controller 361. Among components illustrated in FIG. 26, the same components as those described above are denoted by the same reference numerals. Duplicate descriptions will be omitted as appropriate.

In addition to the cooking arm 321, a camera 401, an olfactory sensor 402, a taste sensor 403, an infrared sensor 404, a texture sensor 405, an environment sensor 406, and a communication unit 407 are connected to the controller 361.

Although not illustrated in FIG. 21 and the like, the same sensor as the sensors provided on the chef side are provided at predetermined positions of the cooking robot 1 itself or around the cooking robot 1. The camera 401, the olfactory sensor 402, the taste sensor 403, the infrared sensor 404, the texture sensor 405, and the environment sensor 406 have functions similar to those of the camera 41, the olfactory sensor 42, the taste sensor 43, the infrared sensor 51, the texture sensor 52, and the environment sensor 53 on the chef side, respectively.

The controller 361 includes a computer including a CPU, a ROM, a RAM, a flash memory, and the like. The controller 361 executes a predetermined program by the CPU to control an overall operation of the cooking robot 1.

In the controller 361, a predetermined program is executed to implement an instruction command acquisition unit 421 and an arm control unit 422.

The instruction command acquisition unit 421 acquires an instruction command transmitted from the control device 12 and received by the communication unit 407. The instruction command acquired by the instruction command acquisition unit 421 is supplied to the arm control unit 422.

The arm control unit 422 controls operation of the cooking arm 321 according to the instruction command acquired by the instruction comm acquisition unit 421.

The camera 401 captures an image of a state of the cooking arm 321 performing the cooking operation, a state of an ingredient to be cooked, and a state on the top board 311A of the cooking robot 1, and outputs an image obtained by the capturing to the controller 361. The camera 401 is provided at various positions such as the front of the cooking assistance system 312 and the distal end of the cooking arm 321.

The olfactory sensor 402 measures an aroma of the ingredient and transmits olfactory sensor data to the controller 361. The olfactory sensor 402 is provided at various positions such as the front of the cooking assistance system 312 and the distal end of the cooking arm 321.

The taste sensor 403 measures a taste of the ingredient and transmits taste sensor data to the controller 361. Also on the reproduction side, for example, the taste sensor 403 such as an artificial lipid membrane type taste sensor is provided.

An attachment having functions as the olfactory sensor 402 and the taste sensor 403 may be prepared and used by being attached to the cooking arm 321 at the time of measurement.

The infrared sensor 404 outputs IR light and generates an IR image. The IR image generated by the infrared sensor 404 is output to the controller 361. Various analyses of the operation of the cooking robot 1, ingredients, and the like may be performed on the basis of the IR image captured by the infrared sensor 404 instead of the image (RGB image) captured by the camera 401.

The texture sensor 405 includes sensors that output various types of sensor data used for texture analysis, such as a hardness sensor, a stress sensor, a moisture content sensor, and a temperature sensor. The hardness sensor, the stress sensor, the moisture content sensor, and the temperature sensor may be provided in the attachment attached to the cooking arm 321 or a cooking tool such as a kitchen knife, a frying pan, or an oven. Sensor data measured by the texture sensor 405 is output to the controller 361.

The environment sensor 406 is a sensor that measures a meal environment that is an environment of a space such as a dining room where a meal of a dish reproduced by the cooking robot 1 is provided. In the example of FIG. 26, the environment sensor 406 includes a camera 441, a temperature and humidity sensor 442, and an illuminance sensor 443. The environment of the reproduction space in which the cooking robot 1 performs cooking may be measured by the environment sensor 406.

The camera 441 outputs an image obtained by capturing the meal space to the controller 361. By analyzing the image obtained by capturing the meal space, for example, the color (lightness, hue, and saturation) of the meal space is measured.

Temperature and humidity sensor 442 measures the temperature and humidity of the meal space, and outputs information indicating a measurement result to the controller 361.

The illuminance sensor 443 measures brightness of the meal space, and outputs information indicating a measurement result to the controller 361.

The communication unit 407 is a wireless communication module such as a wireless LAN module or a portable communication module compatible with long term evolution LTE) . The communication unit 407 communicates with the control device 12 and an external device such as the recipe data management server 21 on the Internet.

Furthermore, the communication unit 407 communicates with a mobile terminal such as a smartphone or a tablet terminal used by the user. The user is a person who eats the dish reproduced by the cooking robot 1. An operation by the user on the cooking robot 1, such as selection of a dish, may be input by an operation on the mobile terminal.

As illustrated in FIG. 26, the cooking arm 321 is provided with a motor 431 and a sensor 432.

The motor 431 provided at each joint part of the cooking arm 321. The motor 431 performs a rotational operation around an axis under control of the arm control unit 422. An encoder that measures a rotation amount of the motor 431, a driver that adaptively controls rotation of the motor 431 on the basis of a measurement result by the encoder, and the like are also provided in each joint part.

The sensor 432 includes, for example, a gyro sensor, an acceleration sensor, a touch sensor, and the like. The sensor 432 measures angular velocity, acceleration, and the like of each joint part during the operation of the cooking arm 321, and outputs information indicating a measurement result to the controller 361. Sensor data indicating a measurement result of the sensor 432 is also appropriately transmitted from the cooking robot 1 to the control device 12.

Information regarding specifications of the cooking robot 1, such as the number of cooking arms 321, is provided from the cooking robot 1 to the control device 12 at a predetermined timing. In the control device 12, planning of operation is performed according to the specifications of the cooking robot 1. The instruction command generated by the control device 12 corresponds to the specifications of the cooking robot 1.

(3-2) Configuration of control device 12

The control device 12 that controls the operation of the cooking robot 1 includes a computer as illustrated in FIG. 19 similarly to the data processing device 11. Hereinafter, the configuration of the data processing device 11 illustrated in FIG. 19 will be appropriately cited and described as a configuration of the control device 12.

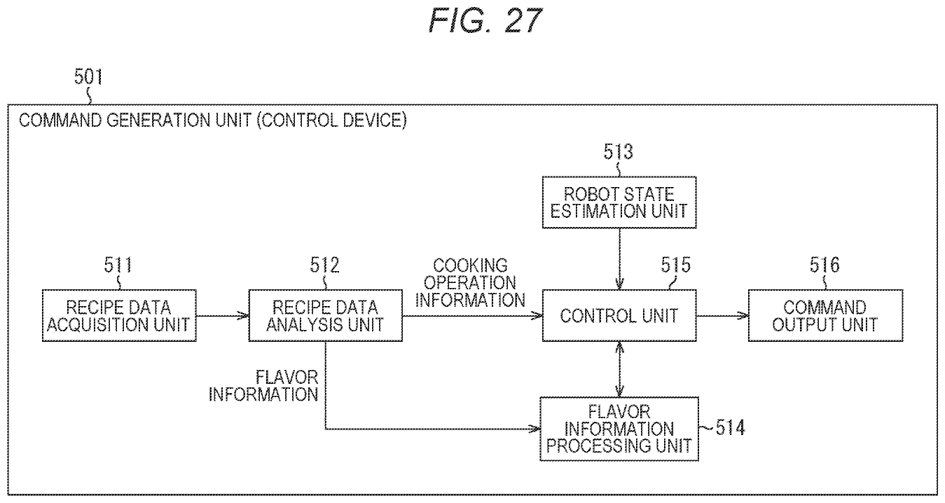

FIG. 27 is a block diagram illustrating a functional configuration example of the control device 12.

At least a part of the functional units illustrated in FIG. 27 is implemented by executing a predetermined program by the CPU 201 (FIG. 19) of the control device 12.

As illustrated in FIG. 27, a command generation unit 501 is implemented in the control device 12. The command generation unit 501 includes a recipe data acquisition unit 511, a recipe data analysis unit 512, a robot state estimation unit 513, a flavor information processing unit 514, a control unit 515, and a command output unit 516.

The recipe data acquisition unit 511 controls the communication unit 209, and acquires the recipe data by receiving the recipe data transmitted from the data processing device 11 or by communicating with the recipe data management server 21, or the like. The recipe data acquired by the recipe data acquisition unit 511 is, for example, recipe data of a dish selected by the user.

A database of recipe data may be provided in the storage unit 208. In this case, the recipe data is acquired from the database provided in the storage unit 208. The recipe data acquired by the recipe data acquisition unit 511 is supplied to the recipe data analysis unit 512.

The recipe data analysis unit 512 analyzes the recipe data acquired by the recipe data acquisition unit 511. When a timing to perform a certain cooking process has come, the recipe data analysis unit 512 analyzes the cooking process data set associated with the cooking process and extracts the cooking operation information and the flavor information. The cooking operation information extracted from the cooking process data set is supplied to the control unit 515, and the flavor information is supplied to the flavor information processing unit 514.

In a case where the recipe data includes the attribute information and the environment information, these pieces of information are also extracted by the recipe data analysis unit 512 and supplied to the flavor information processing unit 514.

The robot state estimation unit 513 controls the communication unit 209 to receive the image and the sensor data transmitted from the cooking robot 1. The image captured by the camera of the cooking robot 1 and sensor data measured by the sensors provided at the predetermined positions of the cooking robot 1 are transmitted from the cooking robot 1 at predetermined cycles. The image captured by the camera of the cooking robot 1 illustrates the situation around the cooking robot 1.

The robot state estimation unit 513 estimates a state around the cooking robot 1 such as a state of the cooking arm 321 and a state of ingredients by analyzing the image and the sensor data transmitted from the cooking robot 1 information indicating the state around the cooking robot 1 estimated by the robot state estimation unit 513 is supplied to the control unit 515.

The flavor information processing unit 514 cooperates with the control unit 515 to control the operation of cooking robot 1 on the basis or the flavor information supplied from recipe data analysis unit 512. The operation of the cooking robot controlled by the flavor information processing unit 514 is, for example, an operation related to adjustment of the flavor of the ingredient.

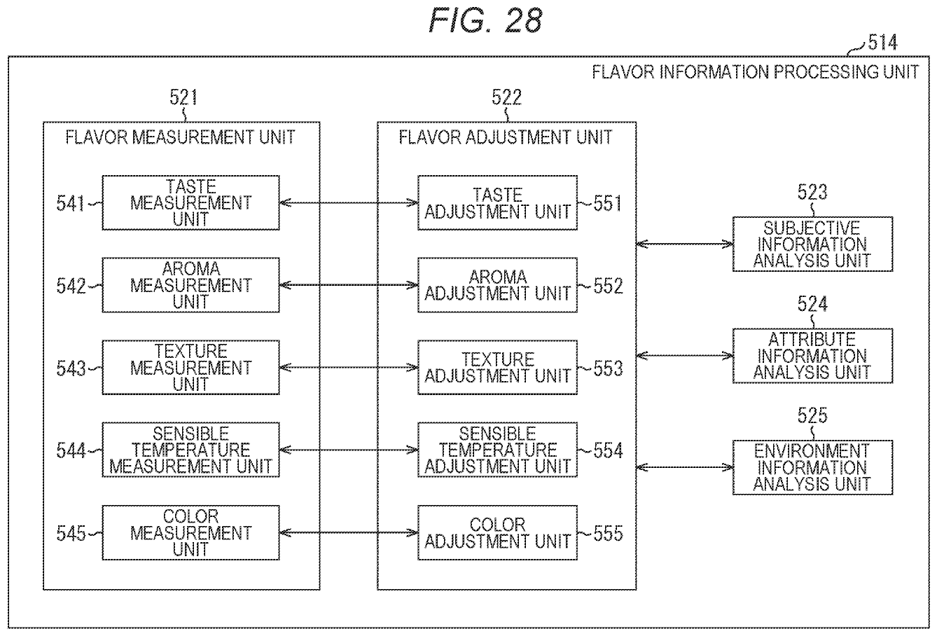

For example, the flavor information processing unit 514 controls the operation of the cooking robot 1 so that the flavor of the ingredient cooked by the cooking robot 1 becomes the same as the flavor indicated by the flavor sensor information. Details of the control by the flavor information processing unit 514 will be described with reference to FIG. 28.

The control unit 515 generates an instruction command and transmits the instruction command from the command output unit 516, to thereby control the operation of the cooking robot 1. The control of the operation of the cooking robot 1 by the control unit 515 is performed on the basis of the cooking operation information supplied from the recipe data analysis unit 512 or on the basis of a request by the flavor information processing unit 514.

For example, the control unit 515 specifies an ingredient to be used in a cooking process to be executed on the basis of the ingredient information included in the cooking operation information. Furthermore, the control unit 515 specifies the cooking tool used in the cooking process and the operation to be executed by cooking arm 321 on the basis of the operation information included in the cooking operation information.

The control unit 515 sets the state in which the ingredient is ready as the goal state, and sets the operation sequence from a current state, which is a current state of the cooking robot 1, to a goal state. The control unit 515 generates an instruction command for causing each operation constituting an operation sequence to be performed, and outputs the instruction command to the command output unit 516.

In the cooking robot 1, the cooking arm 321 is controlled according to the instruction command generated by the control unit 515, and ingredients are prepared. Information indicating the state of the cooking robot 1 at each timing including the state of the cooking arm 321 is transmitted from the cooking robot 1 to the control device 12.

Furthermore, in a case where the ingredients are ready, the control unit 515 sets a state in which cooking using the prepared ingredients (cooking of one cooking process to be executed) is finished completed as the goal state, and sets an operation sequence from the current state to the goal state. The control unit 515 generates an instruction command for causing each operation constituting an operation sequence to be performed, and outputs the instruction command to the command output unit 516.

In the cooking robot 1, the cooking arm 321 is controlled according to the instruction command generated by the control unit 515, and cooking using the ingredients is performed.

In a case where cooking using the ingredients is finished, the control unit 515 generates an instruction command for measuring a flavor and outputs the instruction command to the command output unit 516.

In the cooking robot 1, the cooking arm 321 is controlled according to the instruction command generated by the control unit 515, and the flavor of the ingredients is measured using the camera 401, the olfactory sensor 402, the taste sensor 403, the infrared sensor 404, and the texture sensor 405 as appropriate. Information indicating a measurement result of the flavor is transmitted from the cooking robot 1 to the control device 12.

In the flavor information processing unit 514, how to adjust the flavor and the like are planned, and the flavor information processing unit 514 requests the control unit 515 to perform an operation for adjusting the flavor.

In a case where it is requested to perform the operation for adjusting the flavor, the control unit 515 sets a state in which the operation has ended as the gnarl state, and sets an operation sequence from the current state to the goal state. The control unit 515 outputs an instruction command for causing each operation constituting the operation sequence to be performed to the command output unit 516.

In the cooking robot 1, the cooking arm 321 is controlled according to the instruction command generated by the control unit 515, and an operation for adjusting the flavor is executed.

The control of the operation of the cooking robot 1 by the control unit 515 is performed using, for example, the above instruction command. The control unit 515 has a function as a generation unit that generates an instruction command.

Note that the instruction command generated by the control unit 515 may be a command for giving an instruction on execution of the entire action for causing a certain state shift, or may be a command for giving an instruction on execution of a part of the action. That is, one action may be executed according to one instruction command, or may be executed according to a plurality of instruction commands.

The command output unit 516 controls the communication unit 209 and transmits the instruction command generated by the control unit 515 to the cooking robot 1.

FIG. 28 is a block diagram illustrating a configuration example of the flavor information processing unit 514.

As illustrated in FIG. 28, the flavor information processing unit 514 includes a flavor measurement unit 521, a flavor adjustment unit 522, a subjective information analysis unit 523, an attribute information analysis unit 524, and an environment information analysis unit 525.

The flavor measurement unit 521 includes a taste measurement unit 541, an aroma measurement unit 542, a texture measurement unit 543, a sensible temperature measurement unit 544, and a color measurement unit 545.

The taste measurement unit 541 acquires taste sensor data transmitted from the cooking robot 1 in response to that the measurement of the flavor is performed. The taste sensor data acquired by the taste measurement unit 541 is measured by the taste sensor 403 (FIG. 26). In the cooking robot 1, the flavor of the ingredients is measured at a predetermined timing such as a timing when the cooking operation of a certain cooking process is finished.

The aroma measurement unit 542 acquires olfactory sensor data transmitted from the cooking robot 1 in response to that the measurement of the flavor is performed. The olfactory sensor data acquired by the aroma measurement unit 542 is measured by the olfactory sensor 402.

The texture measurement unit 543 acquires the texture sensor data transmitted from the cooking robot 1 in response to that the measurement of the flavor is performed. The texture sensor data acquired by the texture measurement unit 543 is measured by the texture sensor 405.

The sensible temperature measurement unit 544 acquires the sensible temperature sensor data transmitted from the cooking robot 1 in response to that the measurement of the flavor is performed. The sensible temperature sensor data acquired by the sensible temperature measurement unit 544 is measured by a temperature sensor provided at a predetermined position of the cooking robot 1 such as in the taste sensor 403.

The color measurement unit 545 acquires color sensor data transmitted from the cooking robot 1 in response to that the measurement of the flavor is performed. The color sensor data acquired by the color measurement unit 545 is recognized by analyzing an image captured by the camera 401 of the cooking robot 1.

Sensor data acquired by each unit of the flavor measurement unit 521 is supplied to the flavor adjustment unit 522.

The flavor adjustment unit 522 includes a taste adjustment unit 551, an aroma adjustment unit 552, a texture adjustment unit 553, a sensible temperature adjustment unit 554, and a color adjustment unit 555. The flavor information supplied from the recipe data analysis unit 512 is input to the flavor adjustment unit 522.

The taste adjustment unit 551 compares the taste sensor data constituting the flavor sensor information included in the recipe data with the taste sensor data acquired by the taste measurement unit 541, and determines whether or not the two match. Here, in a case where the same operation as the cooking operation of the chef is performed by the cooking robot 1, it is determined whether or not the taste of the ingredients obtained by the cooking operation of the cooking robot 1 matches the taste of the ingredients obtained by the cooking operation of the chef.

In a case where it is determined that the taste sensor data constituting the flavor sensor information included in the recipe data matches the taste sensor data acquired by taste measurement unit 541, the taste adjustment unit 551 determines that adjustment of the taste is unnecessary.

On the other hand, in a case where it is determined that the taste sensor data constituting the flavor sensor information included in the recipe data does not match the taste sensor data acquired by taste measurement unit 541, the taste adjustment unit 551 performs planning of how to adjust the taste and requests the control an it 515 to perform an operation for adjusting the taste.

The control unit 515 is requested to perform an operation such as adding salt in a case where saltiness is insufficient or squeezing lemon juice in a case where sourness is insufficient.

Similarly, in other processing units of the flavor adjustment unit 522, it is determined whether or not the flavor of the ingredients obtained by the cooking operation of the cooking robot 1 matches the flavor of the ingredients obtained by the cooking operation of the chef, and the flavor is appropriately adjusted.

That is, the aroma adjustment unit 552 compares the olfactory sensor data constituting the flavor sensor information included in the recipe data with the olfactory sensor data acquired by the aroma measurement unit 542, and determines whether or not the two match. Here, it is determined whether or not the aroma of the ingredients obtained by the cooking operation of the cooking robot 1 matches the aroma of the ingredients obtained by the cooking operation of the chef.

In a case where it is determined that the olfactory sensor data constituting the flavor sensor information included in the recipe data matches the olfactory sensor data acquired by the aroma measurement unit 542, the aroma adjustment unit 552 determines that adjustment is unnecessary for the aroma.

On the other hand, in a case where it is determined that the olfactory sensor data constituting the flavor sensor information included in the recipe data does not match the olfactory sensor data acquired by the aroma measurement unit 542, the aroma adjustment unit 552 performs planning of how to adjust the aroma and requests the control unit 515 to perform an operation for adjusting the aroma.

The control unit 515 is requested to perform operations such as squeezing lemon juice in a case where there is grassy smell, and. chopping and adding herbs in a case where the aroma of citrus is weak.

The texture adjustment unit 553 compares the texture sensor data constituting the flavor sensor information included in the recipe data with the texture sensor data acquired by the texture measurement unit 543, and determines whether or not the two match. Here, it is determined whether or not the texture of the ingredients obtained by the cooking operation of the cooking robot 1 matches the texture of the ingredients obtained by the cooking operation of the chef.

In a case where it is determined that the texture sensor data constituting the flavor sensor information included in the recipe data matches the texture sensor data acquired by the texture measurement unit 543, the texture adjustment unit 553 determines that adjustment is not necessary for the texture.

On the other hand, in a case where it is determined that the texture sensor data constituting the flavor sensor information included in the recipe data does riot match the texture sensor data acquired by the texture measurement unit 543, the texture adjustment unit 553 performs planning of how to adjust the texture and requests the control unit 515 to perform an operation for adjusting the texture.

In a case where the ingredient is hard, the control unit 515 is required to perform an operation such as softening by hitting and increasing the time for boiling.

The sensible temperature adjustment unit 554 compares the sensible temperature sensor data constituting the flavor sensor information included in the recipe data with the sensible temperature sensor data acquired by the sensible temperature measurement unit 544, and determines whether or not the two match. Here, it is determined whether or not the sensible temperature of the ingredients obtained by the cooking operation of the cooking robot 1 matches the sensible temperature of the ingredients obtained by the cooking operation of the chef.

In a case where it is determined that the sensible temperature sensor data constituting the flavor sensor information included in the recipe data matches the sensible temperature sensor data acquired by the sensible temperature measurement unit 544, the sensible temperature adjustment unit 554 determines that adjustment is unnecessary for the sensible temperature.

On the other hand, in a case where it is determined that the sensible temperature sensor data constituting the flavor sensor information included in the recipe data does not match the sensible temperature sensor data acquired by the sensible temperature measurement unit 544, the sensible temperature adjustment unit 554 performs planning of how to adjust the sensible temperature and requests the control unit 515 to perform an operation for adjusting the sensible temperature.

The control unit 515 is requested to perform an operation such as heating using an oven in a case where the sensible temperature of the ingredients is low and cooling in a case where the sensible temperature of the ingredients is high.

The color adjustment unit 555 compares the color sensor data constituting the flavor sensor information included in the recipe data with the color sensor data acquired by the color measurement unit 545, and determines whether or not the two match. Here, it is determined whether or not the color of the ingredients obtained by the cooking operation of the cooking robot 1 matches the color of the ingredients obtained by the cooking operation of the chef.

In a case where it is determined that the color sensor data constituting the flavor sensor information included in the recipe data matches the color sensor data acquired by the color measurement unit 545, the color adjustment unit 555 determines that adjustment is unnecessary for the color.

On the other hand, in a case where it is determined that the color sensor data constituting the flavor sensor information included in the recipe data does not match the color sensor data acquired by the color measurement unit 545, the color adjustment unit 555 performs planning of how to adjust the color and requests the control unit 515 to perform an operation for adjusting the color.

In a case where the serving of the cooked ingredients is performed, and the serving manner of the cooking robot 1 is different from the serving manner of the chef, the control unit 515 is requested to perform an operation such as moving the positions of the ingredients so as to approach the serving manner of the chef.

The subjective information analysis unit 523 analyzes the flavor subjective information included in the flavor information, and reflects how the chef feels the flavor indicated by the flavor subjective information on the adjustment of the flavor performed by the flavor adjustment unit 522.

The attribute information analysis unit 524 analyzes the attribute information included in the recipe data, and reflects the attributes of the chef on the flavor adjustment performed by flavor adjustment unit 522.

The environment information analysis unit 525 analyzes the environment information included in the recipe data, and reflects the difference between the cooking environment and the meal environment measured by the environment sensor 406 on the adjustment of the flavor performed by flavor adjustment unit 522.

### OPERATION OF COOKING SYSTEM

Here, operations of the cooking system having the above configuration will be described.

(1) Operation on Chef Side

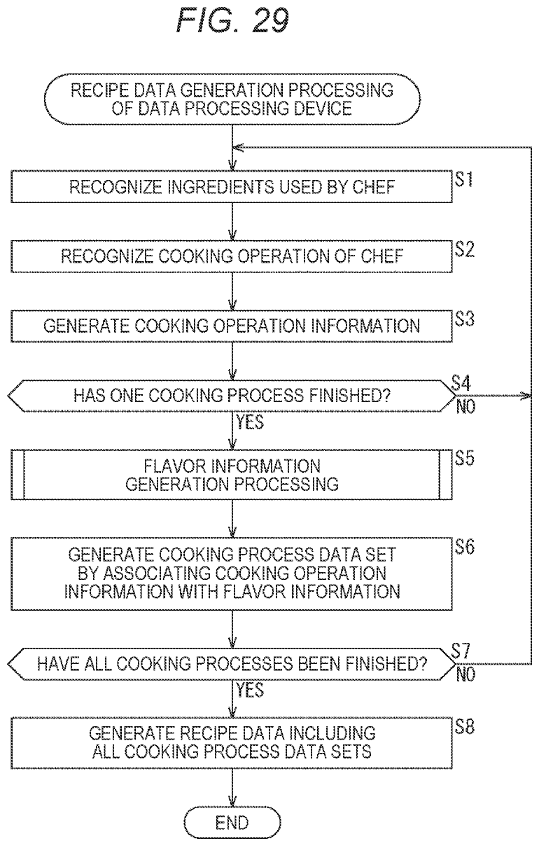

First, recipe data generation processing of the data processing device 11 will be described with reference to a flowchart of FIG. 29.

The processing of FIG. 29 is started when preparation of ingredients and cooking tools is finished and the chef starts cooking. Image capturing by the camera 41, generation of an IR image by the infrared sensor 51, sensing by a sensor attached to the body of the chef, and the like are also started.

In step S1, the ingredient recognition unit 251 in FIG. 20 analyzes the image captured by the camera 41 and recognizes the ingredients used by the chef.

In step S2, the operation recognition unit 253 analyzes an image captured by the camera 41, sensor data representing a measurement result of the sensor attached to the body of the chef, and the like, and recognizes the cooking operation of the chef.

In step S3, the recipe data generation unit 233 generates the cooking operation information on the basis of the ingredient information generated on the basis of the recognition result by the ingredient recognition unit 251 and the operation information generated on the basis of the recognition result by the operation recognition unit 253.

In step S4, the recipe data generation unit 233 determines whether or not one cooking process has been finished, and in a case where it is determined that one cooking process has not been finished yet, the processing returns to step S1 and repeats the above-described processing.

In a case where it is determined in step S4 that one cooking process has been finished, the processing proceeds to step S5.

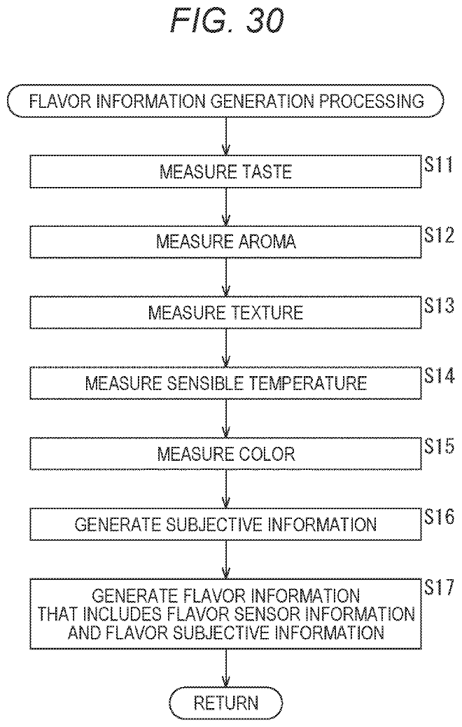

In step S5, flavor information generation processing is performed. The flavor information is generated by the flavor information generation processing. Details of the flavor information generation processing will be described later with reference to a flowchart of FIG. 30.

In step S6, the recipe data generation unit 233 generates the cooking process data set by associating the cooking operation information with the flavor information.

In step S7, the recipe data generation unit 233 determines whether or not all cooking processes have been finished, and in a case where it is determined that all the cooking processes have not been finished yet, the processing returns to step S1 and repeats the above-described processing. Similar processing is repeated for the next cooking process.

In a case where it is determined in step S7 that all the cooking processes have been finished, the processing proceeds to step S8.

In step S8, the recipe data generation unit 233 generates the recipe data including all the cooking process data sets.

Next, the flavor information generation processing performed in step S5 in FIG. 29 will be described with reference to the flowchart in FIG. 30.

In step S11, the taste measurement unit 261 measures the taste of the ingredients by controlling the taste sensor 43.

In step S12, the aroma measurement unit 262 controls the olfactory sensor 42 to measure the aroma of the ingredients.

In step S13, the texture measurement unit 263 measures the texture of the ingredients on the basis of the image captured by the camera 41, the measurement result by the texture sensor 52, and the like.

In step S14, the sensible temperature measurement unit 264 measures the sensible temperature of the ingredients measured by the temperature sensor.

In step S15, the color measurement unit 265 measures the color of the ingredients on the basis of the image captured by the camera 41.

In step S16, the subjective information generation unit 266 generates the flavor subjective information on the basis of the sensor data acquired by each unit of the taste measurement unit 261 to the color measurement unit 265.

In step S17, the recipe data generation unit 233 generates the flavor information on the basis of the flavor sensor information including the sensor data measured by the taste measurement unit 261 to the color measurement unit 265 and the flavor subjective information generated by the subjective information generation unit 266.

After the flavor information is generated, the processing returns to step S5 in FIG. 29, and the processing in step S5 and subsequent steps is performed.

(2) Operation on Reproduction Side

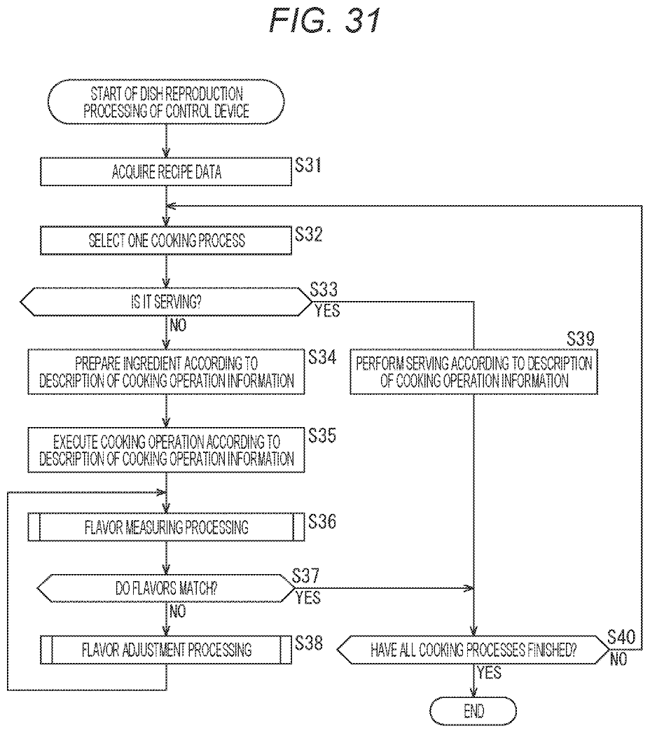

Dish reproduction processing of the control device 12 will be described with reference to a flowchart of FIG. 31.

In step S31, the recipe data acquisition unit 511 in FIG. 27 acquires the recipe data transmitted from the data processing device 11. The recipe data acquired by the recipe data acquisition unit 511 is analyzed by the recipe data analysis unit 512, and the cooking operation information and the flavor information are extracted. The cooking operation information is supplied to the control unit 515, and the flavor information is supplied to the flavor information processing unit 514.

In step S32, the control unit 515 selects one cooking process as an execution target. Selection as the execution target is made sequentially from the cooking process data set associated with the first cooking process.

In step S33, the control unit 515 determines whether or not the cooking process to be executed is a cooking process of serving the cooked ingredients. In a case where it is determined in step S33 that it is not the cooking process of serving the cooked ingredients, the processing proceeds to step S34.

In step S34, the control unit 515 prepares ingredients to be used in the cooking process to be executed on the basis of the description of the ingredient information included in the cooking operation information.

In step S35, the control unit 515 generates an instruction command on the basis of the description of the operation information included in the cooking operation information, and transmits the instruction command to the cooking robot 1, thereby causing the cooking arm 321 to execute the cooking operation.

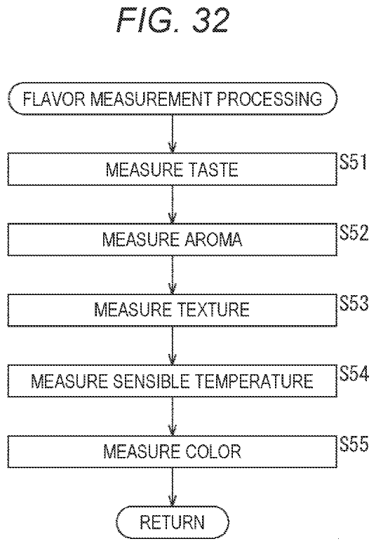

In step S36, flavor measuring processing is performed. The flavor of the cooked ingredients cooked by the cooking robot 1 is measured by the flavor measuring processing. Details of the flavor measuring processing will be described later with reference to the flowchart of FIG. 32.

In step S37, the flavor adjustment unit 522 determines whether or not the flavor of the cooked ingredients matches the flavor indicated by the flavor sensor information included in the recipe data. Here, in a case where the flavor of the cooked ingredients matches the flavor indicated by the flavor sensor information with respect to all of the taste, the aroma, the texture, the sensible temperature, and the color, which are components of the flavor, it is determined that the flavors match.

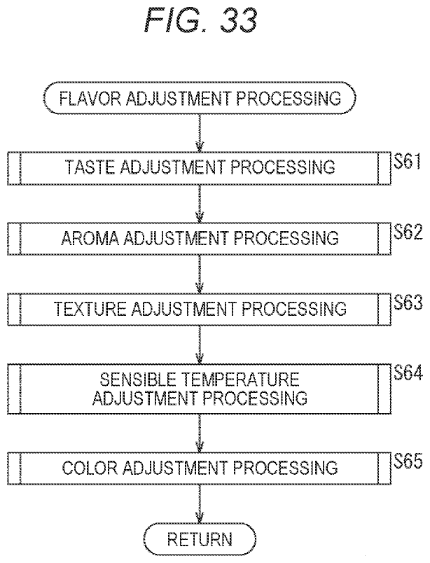

In a case where it is determined in step S37 that the flavors do not match because any of the components does not match, flavor adjustment processing is performed in step S38. The flavor of the cooked ingredients is adjusted by the flavor adjustment processing. Details of the flavor adjustment processing will be described later with reference to a flowchart of FIG. 33.

After the flavor adjustment processing is performed in step S38, the processing returns to step S36, and the above-described processing is repeatedly executed until it is determined that the flavors match.

On the other hand, in a case where it is determined in step S33 that the, cooking process to be executed is the cooking process of serving the cooked ingredient, the processing proceeds to step S39.

In step S39, the control unit 515 generates an instruction command on the basis of the description of the cooking operation information, and transmits the instruction command to the cooking robot 1, thereby causing the cooking arm 321 to perform serving.

In a case where the serving of the ingredients is finished, or in a case where it is determined in step S37 that the flavor of the cooked ingredients matches the flavor indicated by the flavor sensor information included in the recipe data, the processing proceeds to step S40.

In step S40, the control unit 515 determines whether or not all the cooking processes have been finished, and in a case where it is determined that all the cooking processes have not been finished yet, the processing returns to step S32 and repeats the above-described processing. Similar processing is repeated for the next cooking process.

On the other hand, in a case where it is determined in step S40 that all the cooking processes have been finished, the dish is completed, and the dish reproduction processing is terminated.

Next, the flavor measuring processing performed in step S36 in. FIG. 31 will be described with reference to the flowchart in FIG. 32.

In step S51, the taste measurement unit 541 in FIG. 28 causes the cooking robot 1 to measure the taste of the cooked ingredients, and acquires the taste sensor data.

In step S52, the aroma measurement unit 542 causes the cooking robot 1 to measure the aroma of the cooked ingredients, and acquires the olfactory sensor data.

In step S53, the texture measurement unit 543 causes the cooking robot 1 to measure The texture of the cooked ingredients, and acquires the texture sensor data.

In step S54, the sensible temperature measurement unit 544 causes the cooking robot 1 to measure the sensible temperature of the cooked ingredients, and acquires the sensible temperature sensor data.

In step S55, the color measurement unit 545 causes the cooking robot 1 to measure the color of the cooked ingredient, and acquires the color sensor data.

Through the above processing, the flavor of the cooked ingredients is measured, and the ingredients can be used for the flavor adjustment processing described later. Thereafter, the processing returns to step S36 in FIG. 31, and the processing in step S36 and subsequent steps is performed.

Next, the flavor adjustment processing performed in step S38 in FIG. 31 will be described with reference to the flowchart in FIG. 33.

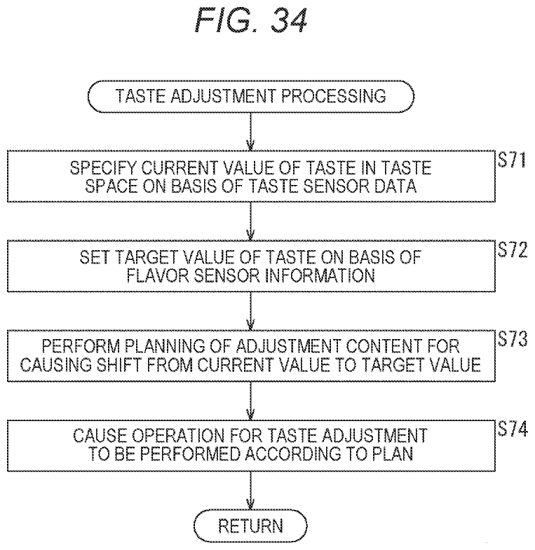

In step S61, the taste adjustment unit 551 performs taste adjustment processing. The taste adjustment processing is performed in a case where the taste of the cooked ingredients does not match the taste indicated by the taste sensor data included in the flavor sensor information. Details of the taste adjustment processing will be described later with reference to a flowchart of FIG. 34.

In step S62, the aroma adjustment unit 552 performs aroma adjustment processing. The aroma adjustment processing is performed in a case where the aroma of the cooked ingredients does not match the aroma represented by the olfactory sensor data included in the flavor sensor information.

In step S63, the texture adjustment unit 553 performs texture adjustment processing. The texture adjustment processing is performed in a case where the texture of the cooked ingredients does not match the texture indicated by the texture sensor data included in the flavor sensor information.

In step S64, the sensible temperature adjustment unit 554 performs sensible temperature adjustment processing. The sensible temperature adjustment processing is performed in a case where the sensible temperature of the cooked ingredients does not match the sensible temperature indicated by the sensible temperature sensor data included in the flavor sensor information.

In step S65, the color adjustment unit 555 performs color adjustment processing. The color adjustment processing is performed in a case where the color of the cooked ingredients does not match the color represented by the color sensor data included in the flavor sensor information.

For example, in a case where an operation of pouring lemon juice on the ingredients in order to increase the sourness is performed as the taste adjustment processing, the aroma of the ingredients is thereby changed, and the aroma may also need to be adjusted. In this case, the aroma adjustment processing is performed together with the taste adjustment processing.

In this manner, adjustment of any element of flavor may affect other elements, and in practice, adjustment of multiple elements is performed. collectively.

Next, taste adjustment processing performed in step S61 in FIG. 33 will be described with reference to the flowchart of FIG. 34.

In step S71, the taste adjustment unit 551 specifies a current value of taste of the cooked ingredients in a taste space on the basis of the taste sensor data acquired by the taste measurement unit 541.

In step S72, the taste adjustment unit 551 sets a target value of taste on the basis of the description of the flavor sensor information included in the recipe data. The taste of the ingredients obtained by the cooking operation performed by the chef, which is represented by the taste sensor data included in the flavor sensor information, is set as the target value.

In step S73, the taste adjustment unit 551 performs planning of the adjustment content for causing the taste of the ingredients to shift from the current value to the target value.

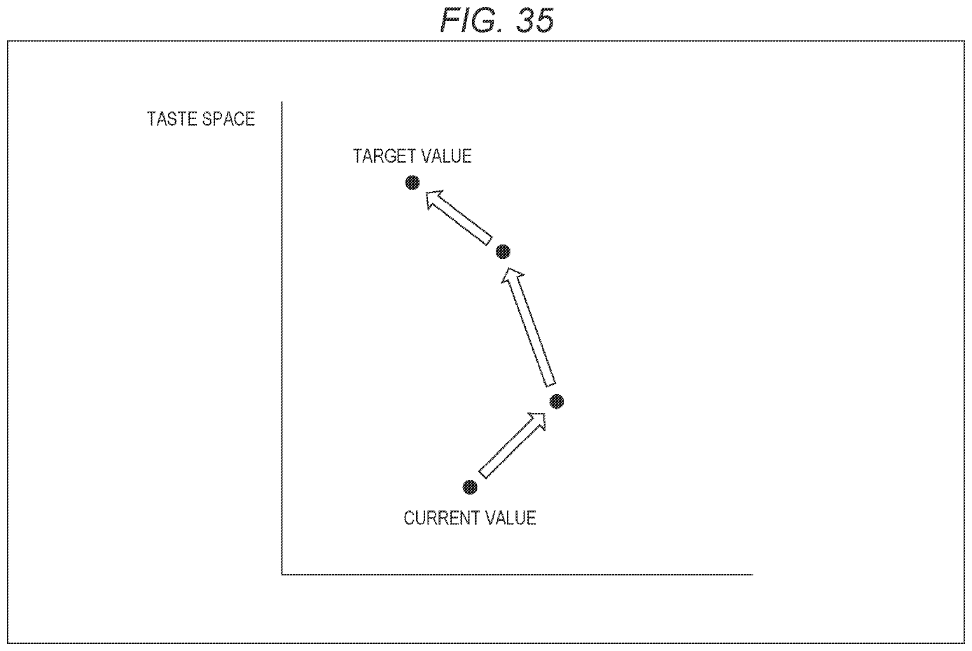

FIG. 35 is a diagram illustrating an example of the planning.

In FIG. 35, a vertical axis represents one of seven types of tastes, and a horizontal axis represents another one. For convenience of explanation, in FIG. 35, the taste space is represented as a two-dimensional space, but in a case where the taste includes seven types of saltiness, sourness, bitterness, sweetness, umami, pungency, and astringency as described above, the taste is a seven-dimensional space.

The taste of the cooked ingredients is represented as a current value by the taste sensor data measured by the cooking robot 1.

Furthermore, the taste serving as the target value is set by the taste sensor data included in the flavor sensor information. The taste serving as the target value is the taste of the ingredients cooked by the chef.

Since there is no seasoning or ingredient that changes only one of saltiness, sourness, bitterness, sweetness, umami, pungency, and astringency, there may be a case where the taste of the ingredients cannot be directly changed from the taste of the current value to the taste of the target value. In this case, as indicated by outlined arrows, planning of the cooking operation for achieving the taste of the target value through a plurality of tastes is performed.

Returning to the description of FIG. 34, in step S74, the taste adjustment unit 551 causes the control unit 515 to perform an operation for adjusting the taste according to the plan.

Thereafter, the processing returns to step S61 in FIG. 33, and the processing in step S61 and subsequent steps is performed.

The aroma adjustment processing (step S62), the texture adjustment processing (step S63), the sensible temperature adjustment processing (step S64), and the color adjustment processing (step S65) are each performed similarly to the taste adjustment processing of FIG. 34. That is, by using the flavor of the cooked ingredients as the current value and the flavor indicated by the flavor sensor information of the recipe data as the target value, the cooking operation for causing the taste of the ingredient to shift from the current value to the target value is performed.

By the above series of processing, a dish having the same flavor as the dish made by the chef is reproduced by the cooking robot 1. The user can eat the dish having the same flavor as the dish made by the chef.

Further, the chef can provide various people with a dish having the same flavor as the dish that he or she made. Furthermore, the chef can leave the dish that he or she makes as the recipe data in a reproducible form.

### MODIFICATION EXAMPLE

Example of Update of Cooking Process on Reproduction Side

There is a case where the same ingredient as the ingredient that is described in the recipe data (ingredient information) as an ingredient to be used for cooking cannot be prepared on the reproduction side. In this case, processing of partially updating the recipe data may be performed by the control unit 515 (FIG. 27).

For example, in a case where a certain ingredient is insufficient, the control unit 515 refers to a substitute ingredient database and selects a substitute ingredient from among ingredients that can be prepared on the reproduction side. The substitute ingredient is an ingredient used instead of an ingredient described in the recipe data as an ingredient used for cooking. The ingredient that can be prepared on the reproduction side is specified, for example, by recognizing the situation around the cooking robot 1.

In the substitute ingredient database referred to by the control unit 515, for example, information regarding the substitute ingredient determined in advance by a food pairing method is described.

For example, in a case where “sea urchin” that is an ingredient described in the recipe data cannot be prepared, the control unit 515 refers to the substitute ingredient database and selects an ingredient in which “pudding” and “soy sauce” are combined as the substitute ingredient. It is well known that the flavor of “sea urchin” can be reproduced by combining “pudding” and “soy sauce”.

The control unit 515 updates the cooking operation information in which the information associated with the cooking process using “sea urchin” is described to the cooking operation information in which information regarding an operation of combining “pudding,” and “soy sauce” and information associated with a cooking process using the substitute ingredient are described. The control unit 515 controls the cooking operation of the cooking robot 1 on the basis of the cooking operation information after update.

The flavor of the substitute ingredient prepared in this manner may be measured, and the flavor may be appropriately adjusted.

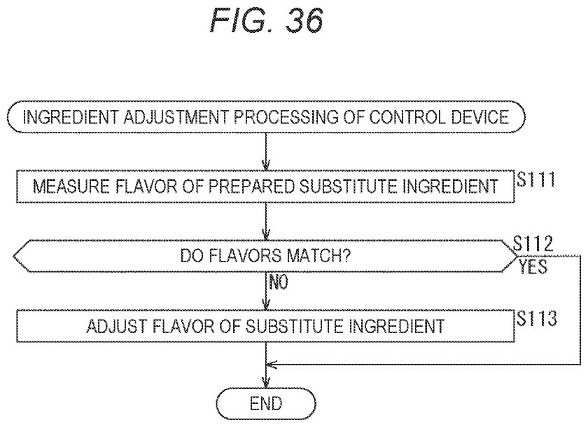

FIG. 36 is a flowchart describing processing of the control device 12 to adjust the flavor of the substitute ingredient.

The processing of FIG. 36 is performed after the substitute ingredient is prepared.

In step S111, the flavor measurement unit 521 of the flavor information processing unit 514 measures the flavor of the prepared substitute ingredient and acquires sensor data indicating the flavor of the substitute ingredient.

In step S112, the flavor adjustment unit 522 determines whether or not the flavor of the substitute ingredient matches the flavor of the ingredient before substitution. In the case of the above-described example, it is determined whether or not the flavor of the substitute ingredient obtained by combining “pudding” and “soy sauce” matches the flavor of “sea urchin”, The flavor of “sea urchin” is specified by the flavor sensor information included in the recipe data.

In a case where it is determined in step S112 that the flavor of the substitute ingredient does not match the flavor of the ingredient before substitution because the sensor data indicating the flavor of the substitute ingredient does not match the flavor sensor information included in the recipe data, the processing proceeds to step S113.

In step S113, the flavor adjustment unit 522 adjusts the flavor of the substitute ingredient. The adjustment of the flavor of the substitute ingredients is performed similarly to the above-described processing of adjusting the flavor of the cooked ingredients.

In a case where the adjustment of the flavor of the substitute ingredient has been performed, or in a case where it is determined in step S112 that the flavor of the substitute ingredient matches the flavor of the ingredient before substitution, the processing of adjusting the flavor of the substitute ingredient ends. Thereafter, processing corresponding to the cooking process after the update is performed using the substitute ingredient.

Thus, even in a case where the same ingredient as the ingredient used on the chef side cannot be prepared on the reproduction side, cooking can proceed using the substitute ingredient. Since the flavor of the substitute ingredient is the same as that of the ingredient before substitution, the dish that is finally completed is a dish having the same or similar flavor as the dish made by the chef.

The substitute ingredient database may be prepared in the control device 12, or may be prepared in a predetermined server such as the recipe data management server 21. The update of the cooking operation information may be performed in the control device 12 or may be performed in the data processing device 11.

Usage Example of Flavor Subjective Information.

In some cases, the specifications of sensors of the both sides may be different such that, for example, a sensor provided on the chef side has higher measurement accuracy than a sensor provided on the reproduction side. In a case where the specifications of the both sides are different, measurement results in a case where the flavor of the same ingredient is measured by the respective sensors are different.

The flavor subjective information is used to enable determination of the flavor of the cooked ingredients by the cooking robot 1 and the flavor of the ingredients cooked by the chef even in a case where the specifications of the sensors provided on both the chef side and the reproduction side are different.

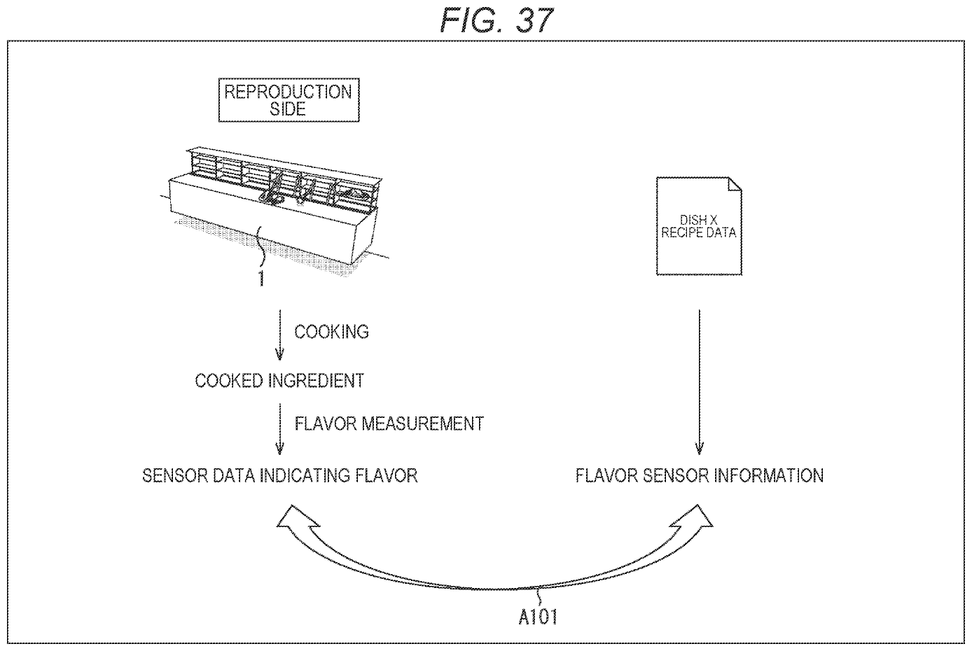

FIG. 37 is a diagram illustrating an example of flavor determination.

In the above-described example, as illustrated on a left side of FIG. 37, in a case where a cooked ingredient is obtained by cooking in a certain. cooking process on the reproduction side, the flavor is measured, and sensor data indicating the flavor of the cooked ingredient is obtained.

Furthermore, as illustrated on a right side of FIG. 37, the flavor sensor information is extracted from the recipe data, and as indicated by an arrow A101, determination of flavor is performed by comparing the sensor data indicating the flavor of the cooked ingredients with the flavor sensor information (determination of whether or not the flavors match).

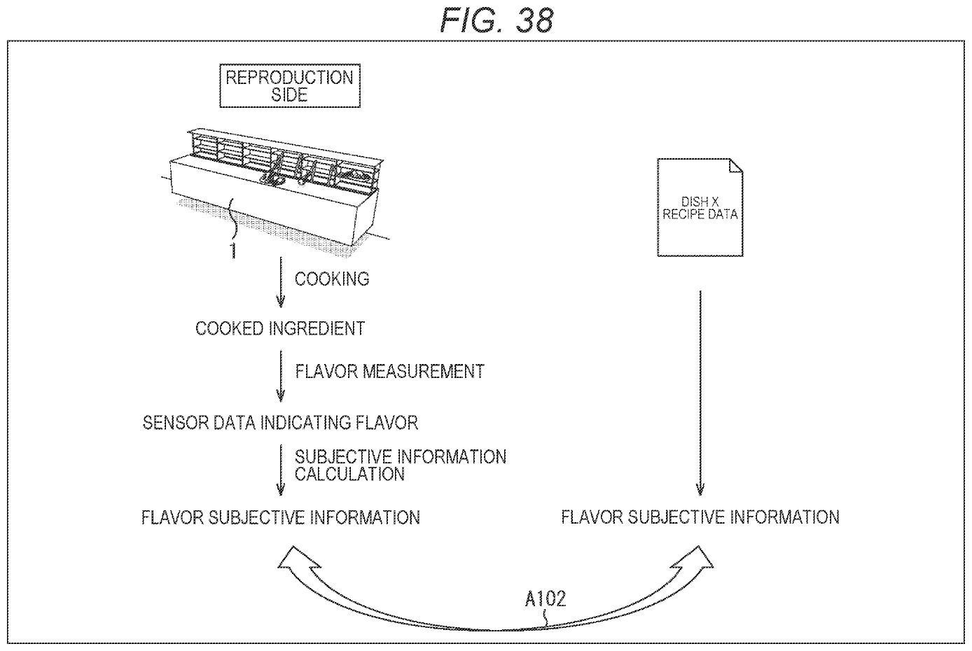

FIG. 38 is a diagram. illustrating an example of the flavor determination using the flavor subjective information.

In a case where the flavor is determined using the flavor subjective information, on the reproduction side, the flavor subjective information is calculated on the basis of the sensor data indicating the flavor of the cooked ingredients, as illustrated on the left side of FIG. 38. For calculation of the flavor subjective information, a model generated on the basis of how the taste of the chef is felt as described with reference to FIG. 6 is used.

The subjective information analysis unit 523 (FIG. 28) of the flavor information processing unit 514 has the same model as the model for generating the taste subjective information prepared on the chef side.

As indicated by an arrow A102, the subjective information analysis unit 523 determines the flavor by comparing the flavor subjective information calculated on the basis of the sensor data indicating the flavor of the cooked ingredients with the flavor subjective information extracted from the recipe data. In a case where the both pieces of the flavor subjective information match, it is determined that the flavors match, and the processing of the next cooking process is performed.

Thus, even in a case where the specifications of the sensors provided on both the chef side and the reproduction. side are different, it is possible to reproduce ingredients and a dish having the same flavors as flavors felt by the chef.

Thus, as the mode for determining the flavor, a mode based on the sensor data and a mode based on the flavor subjective information are prepared.

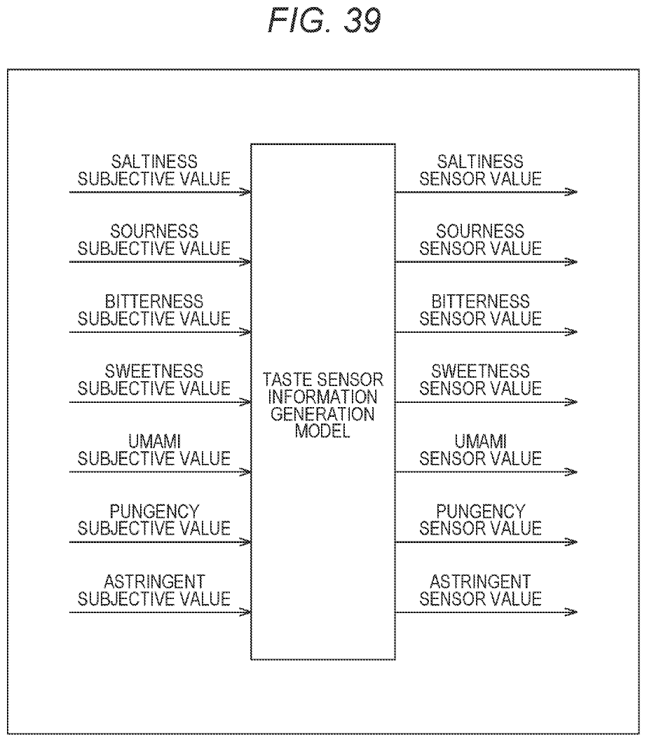

FIG. 39 a diagram illustrating an example of a model for generating sensor data.

As illustrated in FIG. 39, a model capable of calculating sensor data under the specifications of the sensor provided on the reproduction side on the basis of the flavor subjective information included in the recipe data may be prepared in the subjective information analysis unit 523.

A taste sensor information generation model illustrated in FIG. 39 is a model of a neural network or the like generated by performing deep learning or the like on the basis of sensor data related to taste measured by the sensor prepared on the reproduction side and a subjective value indicating how the chef feels a taste. For example, by a manager who manages the recipe data, a model corresponding to specifications of various sensors is prepared and provided to the reproduction side.

In this case, the subjective information analysis unit 523 calculates The corresponding sensor data by inputting the flavor subjective information to the model. The subjective information analysis unit 523 determines the flavor by comparing the sensor data obtained by measuring the flavor of the ingredients cooked by the cooking robot 1 with the sensor data calculated using the model.

Usage Example of Attribute Information

The recipe data includes the attribute information indicating attributes of the chef, and the like. Since age, sex, nationality, living area, and the like affect how the flavor is felt, the flavor of the reproduced ingredients may be adjusted according to a difference between the attributes of the chef and attributes of the person who eats the dish reproduced by the cooking robot 1.

The cook attribute information, which is the attribute information extracted from the recipe data, is supplied to the attribute information analysis unit 524 and used for controlling the flavor adjustment performed by the flavor adjustment unit 522. Eating person attribute information indicating attributes of an eating person input by the person who eats the dish reproduced by the cooking robot 1 is also supplied to the attribute information analysis unit 524.

The attribute information analysis unit 524 specifies the attributes of the chef on the basis of the cook attribute information, and specifies the attributes of the eating person on the basis of the eating person attribute information.

For example, in a case where the age of the eating person greatly exceeds the age of the chef, and the attribute information analysis unit 524 specifies that the eating person is an elderly person, the texture of the ingredient is adjusted to be soft.

Furthermore, in a case where the nationality of the eating person and the nationality of the chef are different, the attribute information analysis unit 524 controls the flavor of the ingredient adjusted by the flavor adjustment unit 522 according co the difference in nationality on the basis of the information prepared in advance as described above. Similarly, in a case where other attributes of the eating person and the chef are different, such as gender and living area, the attribute information analysis unit 524 controls the flavor of the ingredients adjusted by the flavor adjustment unit 522 according to the difference between the attributes.

Thus, a dish in which the flavor is finely adjusted according to a preference of the eating person is reproduced although the flavor is basically the same as the way the chef feels.

Furthermore, the attribute information analysis unit 524 specifies attributes of the ingredients on the basis of food attribute information and specifies the attributes of the ingredients prepared on the reproduction side.

In a case where the attributes of the ingredients used on the chef side are different from the attributes of the ingredients prepared on the reproduction side, the attribute information analysis unit 524 controls the flavor of the ingredients adjusted by the flavor adjustment unit 522 according to the difference in the attributes.

In this manner, the flavor of the ingredients may be adjusted on the reproduction side on the basis of the difference in various attributes between the chef side and the reproduction side.

Usage Example of Environment Information

(1) Adjustment of Meal Environment

The recipe data includes the environment information indicating the cooking environment that is an environment of a space where the chef performs cooking. Since the color, temperature, brightness, and the like of the space affect how the flavor is felt, adjustment may be performed to bring a meal environment such as a dining room in which a meal of a dish reproduced by the cooking robot 1 is eaten closer to the cooking environment. The environment information extracted from the recipe data is supplied to the environment information analysis unit 525 and used for adjusting the meal environment.

For example, the environment information analysis unit 525 controls lighting equipment in the dining room so that the color of the meal environment measured by analyzing the image captured by the camera 441 (FIG. 26) approaches the color of the cooking environment indicated by the environment information. The environment information analysis unit 525 has a function as an environment control unit that adjusts the meal environment by controlling an external device.

Furthermore, the environment information analysis unit 525 controls an air conditioning apparatus in the dining room so as to bring the temperature and humidity of the meal environment measured by the temperature and humidity sensor 442 closer to the temperature and humidity of the cooking environment indicated by the environment information.

The environment information analysis unit 525 controls lighting equipment in the dining room so that the brightness of the meal environment measured by the illuminance sensor 443 approaches the brightness of the cooking environment indicated by the environment information.

Thus, the meal environment can be brought closer to the cooking environment, and how the person who eats the dish reproduced by the cooking robot. I feels the flavor can be brought closer to how the chef feels the flavor.

(2) Correction of Flavor Sensor Information

Information regarding the specifications of the sensor provided on the chef side may be included in the environment information and provided co the reproduction side. On the reproduction side, the flavor sensor information included in the recipe data is corrected on the basis of a difference between the sensor provided on the chef side and the sensor provided on the reproduction side.

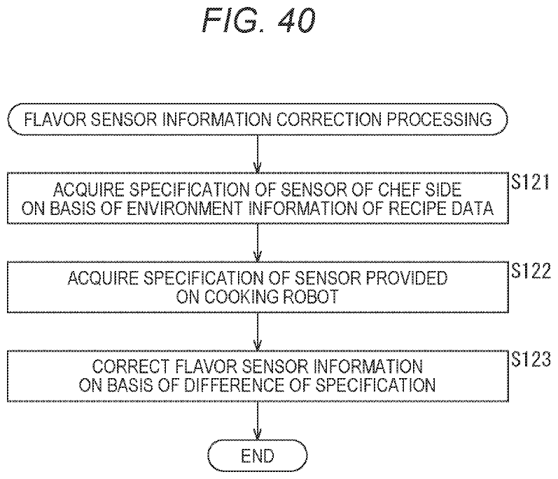

FIG. 40 is a flowchart describing processing of the control device 12 to correct the flavor sensor information.

In step S121, the environment information analysis unit 525 acquires the specifications of the sensors provided on the chef side on the basis of the environment information included in the recipe data.

In step S122, the environment information analysis unit 525 acquires the specifications of the sensors provided around the cooking robot 1 on the reproduction side.

In step S123, the environment information analysis unit 525 corrects the flavor sensor information included in the recipe data, which is the sensor data measured on the chef side, on the basis of differences between the specifications of the sensors provided on the chef side and the specifications of the sensors provided around the cooking robot 1. Information indicating correspondence relationships between measurement results of the sensors provided on the chef side and measurement results of the sensors provided on the reproduction side are prepared as information for correction for the environment information analysis unit 525.

The flavor sensor information thus corrected is used for flavor determination. Thus, it is possible to absorb differences in environment to determine the flavor.

<Others>

Modification Example of Configuration

Although the cooking robot that reproduces a dish on the basis of the recipe data is the cooking robot 1 installed at home, the dish may be reproduced by the cooking robot provided in various places. For example, the above-described technique is also applicable to a case where a dish is reproduced by a cooking robot provided in a factory or a cooking robot provided in a restaurant.

Furthermore, the, cooking robot that reproduces a dish on the basis of the recipe data is assumed to be the cooking robot 1 that operates the cooking arm to perform cooking, but the dish may be reproduced by various cooking robots that can cook ingredients by a configuration other than the cooking arm.

In the above description, control of the cooking robot 1 is performed by the control device 12, but may be directly performed by the data processing device 11 that generates the recipe data. In this case, the data processing device 11 is provided with each configuration of the command generation unit 501 described with reference to FIG. 27.

Furthermore, each configuration of the command generation unit 501 may be provided in the recipe data management server 21.

The server function of the recipe data management server 21 that manages the recipe data and provides the recipe data to another device may be provided in the data processing device 11 that generates the recipe data.

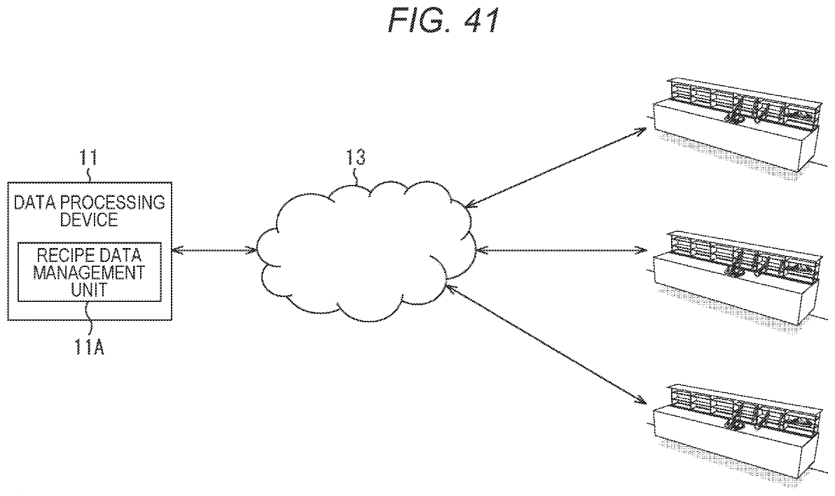

FIG. 41 is a diagram illustrating another configuration example of the cooking system.

A recipe data management unit 11A included in the data processing device 11 has a server function of managing the recipe data and providing the recipe data to another device. The recipe data managed by the recipe data management unit 11A is provided to a plurality of cooking robots and a control device that controls the cooking robot.

Data Management

The recipe data, the cooking process data sets (the cooking operation information and the flavor information), and the like described above can be considered as works since they can be said to be products that creatively express ideas and emotions regarding the cooking process.

For example, the chef who performs cooking (for example, a chef who runs a famous restaurant) completes a delicious dish with creativity while repeating trials such as selection of ingredients and tasting in the cooking process. In this case, there is a value as data in the recipe data and the cooking process data sets (the cooking operation information and the flavor information), and a situation where others need to pay the value when using them can be assumed.

Therefore, an application example is also conceivable in which copyright management of the recipe data, the cooking process data sets (the cooking operation information and the flavor information), and the like is performed similarly to that for music and the like.

That is, in the present disclosure, it is also possible to protect individual recipe data and cooking process data sets by using a copyright protection technology such as copy prevention, encryption, or the like that provides a protection function for individual data.

In this case, for example, the recipe data management server 21 of FIG. 14 (the data processing device 11 of FIG. 41) manages the chef and the recipe data (or the cooking process data sets) in a state that copyright is managed in a form that the chef and the recipe data are associated with. each other.

Next, in a case where the user desires to cause the cooking robot 1 to perform cooking using the recipe data, the user pays a usage fee for this recipe data, and thus, for example, the recipe data downloaded to the control device 12 can be used for cooking in the cooking robot 1. Note that the usage fee is returned to a chef who is the creator of the recipe data, a data manager who manages the recipe data, and the like.

Furthermore, in the present disclosure, it is also possible to protect individual recipe data and cooking process data sets by using a blockchain technology in which a transaction history of data is managed in a distributed manner as a ledger by a server.

In this case, for example, the recipe data management server 21 of FIG. 14 (the data processing device 11 of FIG. 41) manages the chef and the recipe data (or the cooking process data sets) in the associated form using the blockchain technology in which a transaction history of data is managed in a distributed mariner as a ledger by a server (cloud server, edge server, or the like).

Next, in a case where the user desires to cause the cooking robot 1 to perform cooking using the recipe data, the user pays a usage fee for this recipe data, and thus, for example, the recipe data downloaded to the control device 12 can be used for cooking in the cooking robot 1. Note that the usage fee is returned to a chef who is the creator of the recipe data, a data manager who manages the recipe data, and the like.

Thus, it is possible to efficiently manage the recipe data (or the cooking process data sets) as a work expressed in a creative form in consideration of each relationship among the chef, the user, and the usage fee,

Characterization of Ingredient using Temperature Change in Absorption Spectrum

Although the flavor of ingredients is represented by the sensor data of taste, aroma, texture, and the like, the flavor of ingredients may be represented by other indexes. As an index expressing the flavor of ingredients, a temperature change of an absorption spectrum can be used.

Principle

An absorption spectrum of a specimen (ingredient) is measured using a spectrophotometer. The absorption spectrum changes according to the temperature of the specimen. The following reaction is considered as a background in which the absorption spectrum changes as the temperature rises.

(1) Dissociation from Association

An associated state (a state in which two or more molecules move like one molecule due to a weak bond between the molecules) of components contained in the specimen changes depending on the temperature. When the temperature decreases, the molecules are easily associated or aggregated, and conversely, when the temperature increases, molecular vibrations intensify, and thus the molecules are easily dissociated from the association. Therefore, the peak value of an absorption wavelength derived from the association decreases, and the peak value of an absorption wavelength derived from the dissociated single molecules increases.

(2) Molecular Decomposition by Thermal Energy

By absorbing heat, a portion having a weak bonding force comes off, and molecules are divided.

(3) Degradation of Molecules by Enzymatic Activity

The molecule is split via a degrading enzyme.

(4) Oxidative Reduction

As the temperature increases, the pH of water decreases (H+ concentration increases). In cases of fats and oils, the oxidation rate increases.

Here, from the viewpoint of taste and aroma of natural products such as ingredients, among components contained in the natural products, a taste substance is a component contained in a liquid phase, and an aroma substance is a volatile component contained in a gas phase.

The molecules in the associated state are less likely to be in the gas phase, and the single molecules dissociated from the associated state are likely to be transferred to the gas phase.

Moreover, for example, terpenes deeply associated with aromas are present in the form of glycosides with sugars in plants, but become the form of aglycones with sugars removed and become easy to volatilize by thermal or enzymatic decomposition.

Therefore, when the temperature increases, the number of molecules easy to volatilize increases, the peak value of the absorption wavelength of the aroma substance on the verge of volatilization increases, and the peak value of the absorption wavelength related to the group of molecules with which the aroma substance has been associated so far decreases.

From this property, it can be considered that the temperature change of the absorption. spectrum reflects a phase transition from the liquid phase related to “taste” to the gas phase related to “aroma”.

Accordingly, a target specimen can be kept warm at at least two or more different temperatures, and the absorption spectrum of the specimen in each warm state can be measured, so as to use the data set thereof as information characterizing the taste and aroma of the specimen. From the characteristic (pattern) of the data set of the absorption spectrum, the specimen can be identified.

It can be said that this is in consideration of the fact that the probability of occurrence of the phase transition from the liquid phase to the gas phase increases as a result of the dissociation from association of molecules or the decomposition of molecules by thermal decomposition and enzymatic decomposition, and of the temperature change of the absorption spectrum. This method can be said to be a method of characterizing the specimen by the absorption spectrum of three-dimensional data by adding a dimension of temperature to the absorption. spectrum represented as two-dimensional data of wavelength and absorbance.

Regarding Program

The series of processes described above can be executed by hardware or can be executed by software. In a case where the series of processing is executed by software, a program constituting the software is installed on a computer built into dedicated hardware, a general-purpose personal computer, or the like.

The program to be installed is provided by being recorded in the removable medium 211 illustrated in FIG. 19 including an optical disk (compact disc-read only memory (CD-ROM), digital versatile disc (DVD), or the like), a semiconductor memory, and the like. Furthermore, the information may be provided via a wired or wireless transmission medium such as a local area network, the Internet, or digital broadcasting. The program can be installed in the ROM 202 or the storage unit 208 in advance.

The program executed by the computer may be a program for processing in time series in the order described in the present description, or a program for processing in parallel or at a necessary timing such as when a call is made.

Note that in the present description, a system means a set of a plurality of components (devices, modules (parts), and the like), and it does not matter whether or not all the components are in the same housing. Therefore, both of a plurality of devices housed in separate housings and connected via a network and a single device in which a plurality of modules is housed in one housing are systems.

The effects described herein are merely examples and are not limited, and other effects may be provided.

The embodiments of the present technology are not limited to the above-described embodiments, and various modifications are possible without departing from the gist of the present technology.

For example, the present technology can employ a configuration of cloud computing in which one function is shared by a plurality of devices via a network and processed jointly.

Furthermore, each step described in the above-described flowcharts can be executed by one device, or can be executed in a shared manner by a plurality of devices.

Moreover, in a case where a plurality of processes is included is one step, the plurality of processes included is the one step can be executed in a shared manner by a plurality of devices in addition to being executed by one device.

### REFERENCE SIGNS LIST

1 Cooking robot
11 Data processing device
12 Control device
21 Recipe data management server
41 Camera
42 Olfactory sensor
43 Taste sensor
51 Infrared sensor
52 Texture sensor
53 Environment sensor
221 Data processing unit
231 Cooking operation information generation unit
232 Flavor information generation unit
233 Recipe data generation unit
234 Environment information generation unit
235 Attribute information generation unit
236 Recipe data output unit
321 Cooking arm
361 Controller
401 Camera
402 Olfactory sensor
403 Taste sensor
404 Infrared sensor
405 Texture sensor
406 Environment sensor
407 Communication unit
501 Information processing unit
511 Recipe data acquisition unit
512 Recipe data analysis unit
513 Robot state estimation unit
514 Flavor information processing unit
515 Control unit
516 Command output unit

1. A data processing device comprising
a recipe data generation unit that generates recipe data including a data set used when a cooking robot performs a cooking operation, the data set linking cooking operation data in which information regarding an ingredient of a dish and information regarding an operation of a cook in a cooking process using the ingredient are described, and sensation data indicating a sensation of the cook measured in conjunction with progress of the cooking process.

2. The data processing device according to claim 1, wherein
the sensation data is data indicating at least one of a flavor of the ingredient before cooking, a flavor of the ingredient after cooking that is cooked in the cooking process, or a flavor of a dish completed through all the cooking processes.

3. The data processing device according to claim 2, wherein
the sensation data includes taste information indicating at least one of sweetness, sourness, saltiness, bitterness, umami, pungency, or astringency.

4. The data processing device according to claim 3, wherein.
the taste information is sensor information measured by a taste sensor.

5. The data processing device according to claim 3, wherein
the sensation data includes other information regarding a taste obtained by using the taste information as an input to a model generated by performing deep learning.

6. The data processing device according to claim 5, wherein
the other information regarding the taste is subjective data indicating how a person feels a taste.

7. The data processing device according to claim 2, wherein
the sensation data includes texture information indicating texture of at least one of texture of the ingredient or texture of the dish.

8. The data processing device according to claim 7, wherein
the texture information is information indicating at least one of stress, hardness, or moisture content measured by a sensor.

9. The data processing device according to claim 2, wherein
the recipe data includes cooking environment data indicating as environment of a cooking space measured in conjunction with progress of the cooking process.

10. The data processing device according to claim 9, wherein
the cooking environment data is data indicating at least one of temperature, humidity, atmospheric pressure, brightness, hue, or saturation of the cooking space.

11. The data processing device according to claim 1, wherein
the recipe data includes food attribute information indicating at least one of an attribute of the ingredient before cooking, an attribute of the ingredient after cooking that is cooked in the cooking process, or an attribute of a dish completed through all the cooking processes.

12. The data processing device according to claim 11, wherein
in the cooking operation data, a type and an amount of seasoning used in the cooking process are described, and
the recipe data includes seasoning attribute information indicating an attribute of the seasoning.

13. The data processing device according to claim 1, wherein
the recipe data includes cook attribute information indicating as attribute of the cook.

14. The data processing device according to claim 1, further comprising
a command generation unit that generates an instruction command that gives an instruction on the cooking operation to be executed by the cooking robot on a basis of the recipe data generated by the recipe data generation unit.

15. The data processing device according to claim 14, wherein
the cooking robot includes an arm.

16. The data processing device according to claim 15, wherein.
the cooking robot performs the cooking operation by causing a plurality of the arms to cooperate according to the instruction command.

17. The data processing device according to claim 1, further comprising
a recipe management unit that implements a server function that manages the recipe data and provides the recipe data to the cooking robot connected via a network.

18. A data processing method comprising, by a data processing device,
generating recipe data including a data set used when a cooking robot performs a cooking operation, the data set linking cooking operation data in which information regarding an ingredient of a dish and information regarding an operation of a cook in a cooking process using the ingredient are described, and sensation data indicating a sensation of the cook measured in conjunction with progress of the cooking process.
